(19) United States
(12) Patent Application Publication
(10) Pub. No.: US 2008/0011514 A1
(43) Pub. Date: Jan. 17, 2008

(54) Optical Fiber Distribution Apparatus and Method

(75) Inventors: Wenxin Zheng, Ellicott City, MD (US); Neal Zumovitch, Franklin, TN (US); Mikael Kostet, Umea (SE)

Correspondence Address: BANNER & WITCOFF, LTD., 1100 13th STREET, N.W., SUITE 1200, WASHINGTON, DC, 20005-4051, US

(73) Assignee: Tenvera, Inc., Franklin, TN (US)

(21) Appl. No.: 11/551,111

(22) Filed: Oct. 19, 2006

Related U.S. Application Data
(60) Provisional application No. 60/830,663, filed on Jul. 14, 2006.

(51) Int. Cl. H02G 15/08

(52) U.S. Cl. 174/72 R

(57) ABSTRACT

A system and apparatus for storing and organization optical fibers and fiber dispensing reels are provided. The storage system may include a housing having multiple mandrels configured to receive one or more fiber dispensing reels. The mandrels may further be configured to allow stacking of multiple dispensing reels on a single mandrel. The storage system may further include one or more sets of openings located in one or more sidewalls of the housing. The openings may allow a conduit to be connected to the storage system to facilitate installation. Further, each opening may include a grommet to secure the conduits using friction. A top cover of the housing may be removable to allow easier access to the interior of the storage system. A front panel of the housing may include connectors and/or adaptors for attaching service connections.

### RELATED APPLICATIONS

The present application claims priority to U.S. provisional patent application Ser. No. 60/830,663, filed Jul. 14, 2006, entitled “Fiber in the Home,” incorporated by reference herein as to its entirety.

### BACKGROUND

In a society where the thirst for high-speed information access is ever growing, the underlying infrastructure has struggled to meet demand. From television to telecommunications to computer gaming, information networks are expected to facilitate the transmission of a significant amount of data and content. For example, cable television and Internet services often share the same cabling and bandwidth. Accordingly, during peak times of usage or if other services are added further sharing the same bandwidth, slow downs and disruptions in service may result. Since current information networks are predominantly implemented using such copper wiring, the ability of information networks to handle increasing bandwidth requirements is quickly fading.

Fiber optic cabling has also been used in many networking solutions and architectures as a solution to increasing bandwidth demands and requirements. Fiber optic cabling is able to handle an amount of bandwidth much greater than the capacity of copper wiring. However, fiber optics have not been widely adopted due to prohibitive material and installation costs. Thus, real estate developers often opt for copper cabling for residential and commercial developments to keep costs at a manageable and attractive level. To subsequently provide these developments with fiber optic cabling involves additional retrofitting costs on top of the already expensive installation and material costs. One aspect of the installation process that can increase costs is the time and equipment needed to configure a node end of a fiber optic cable for attachment to an outlet. Current methods of installing fiber optic cable in an outlet call for fusion splicing and/or mechanical modifications to the node end of the fiber optic cable. Both fusion splicing and mechanical adaptation processes also take significant amounts of installation time and thus, labor costs are also increased.

Another aspect of fiber optic installation that may lead to increases in costs is the time needed to organize multiple fiber optic cables. Since fiber optic cables are thin and multiple fibers are typically installed throughout a building, the cables may become tangled or otherwise disorganized. As such, an installer may spend additional time to organize the cables to determine which cable leads to which destination.

### SUMMARY

This summary is provided to introduce a selection of concepts in a simplified form that are further described below in the Detailed Description. This summary is not intended to identify key features or essential features of the claimed subject matter, and instead presents various illustrative aspects described herein.

At least some of the aforementioned problems may be addressed by implementing an optical distribution frame for installing and storing fiber optic cables. The optical distribution frame may be implemented at a service aggregation point in a home or other building for organization of fiber optic cables and/or reels to which the cables may attached. For example, the optical distribution frame may include structural components such as a base plate, front panel, top cover, first and second side walls and a back wall. Multiple mandrels to which dispensing reels may be attached may extend from the base plate. In one or more configurations, multiple dispensing reels may be stacked on top of one another on a single mandrel to conserve space. The mandrels may be positioned such that a first reel placed on a first mandrel does not interfere or overlap with a second reel placed on a second mandrel.

The optical distribution frame may further include multiple openings in one or more walls. For example, one set of openings may be built into a side wall and a second set of openings may be built into the back wall. Such a configuration allows a user to connect a fiber and conduit through a convenient wall/location of the frame. The openings may be configured to secure one or more conduits to the frame and to allow a fiber optic cable to pass into the optical distribution frame. Additionally or alternatively, one or more openings may include grommets so that a conduit may be attached through the openings using friction. A front panel of the optical distribution frame may further include adapters for connecting fiber optic cables stored in the optical distribution frame to one or more service connections. Top cover may be removable so that a user may more easily access the interior of the distribution frame. Mounting brackets may also be attached to the frame so that the frame may be secured to a service rack.

These and other aspects of the disclosure will be apparent upon consideration of the following detailed description of illustrative embodiments.

### BRIEF DESCRIPTION OF THE DRAWINGS

FIG. 1 is a front cut-away view of an illustrative habitable building including a local optical network and a service aggregation gateway.

FIG. 2 is an illustrative functional block diagram of the service aggregation gateway of FIG. 1.

FIG. 3 is another illustrative functional block diagram of the service aggregation gateway of FIG. 1.

FIG. 4 is a front view of an illustrative rack of the service aggregation gateway of FIG. 1.

FIG. 5 is a front view of an illustrative rack unit of the service aggregation gateway of FIG. 1.

FIG. 6 is a front view of the rack unit of FIG. 5 with all rack sub-units removed.

FIG. 7 is a top view of the rack unit of FIG. 5 with all rack sub-units removed.

FIG. 8 is a top view of an illustrative rack sub-unit.

FIG. 9 is a side cut-away view of an illustrative wall of the building of FIG. 1.

FIG. 10 is a cross-sectional view of an illustrative conduit containing an optical fiber of the local optical network of FIG. 1.

FIG. 11 is a side cut-away view of an illustrative universal outlet frame attached to an illustrative mount.

FIG. 12 is a side cut-away view of the universal outlet frame of FIG. 11.

FIG. 13 is a face view of the universal outlet frame of FIG. 11.

FIG. 14 is a side cut-away view of an illustrative wall module plugged into the universal outlet frame of FIG. 11, and of the universal outlet frame attached to the mount of FIG. 11.

FIG. 15 is a face view of the wall module of FIG. 14.

FIG. 16 is a side cut-away view of the wall module of FIG. 14.

FIG. 17 is a side cut-away view of another example of a wall module.

FIG. 18 is a front perspective exploded view of another example of a mount, universal outlet frame, and wall module designed to fit together.

FIG. 19 is a rear perspective exploded view of what is shown in FIG. 18.

FIG. 20 is a front perspective view of the mount, universal outlet frame, and wall module of FIG. 18 when they are fit together, with the cover plate of the wall module removed so as to more easily depict the various parts.

FIG. 21 is a front perspective view of an illustrative optical fiber ferrule holder.

FIG. 22 is a front perspective view of the ferrule holder of FIG. 21 including an illustrative spring and also holding an illustrative ferrule.

FIG. 23 is a perspective view of the ferrule of FIG. 22.

FIG. 24 is a side view of the ferrule of FIG. 22, including an illustration of how the ferrule may fit within the ferrule holder of FIG. 21.

FIG. 25 includes both a side cut-away view and non-cut-away view of the ferrule of FIG. 22.

FIG. 26 is a side cut-away view of another illustrative wall module including a set of triple-play user connectors.

FIG. 27 is a face view of the wall module of FIG. 26.

FIG. 28 is a diagram of a fiber blowing system according to one or more aspects described herein.

FIG. 29 illustrates a user interface of a display device associated with a fiber blowing system according to one or more aspects described herein.

FIGS. 30-32 are diagrams illustrating various views of a fiber dispensing reel according to one or more aspects described herein.

FIG. 33 is a cross-sectional diagram of the fiber dispensing reel shown in FIG. 30, taken along line A-A′ according to one or more aspects described herein.

FIG. 34 is a diagram illustrating a front perspective view of an optical distribution frame (ODF) in an open position in which one or more aspects described herein may be implemented.

FIG. 35 is a diagram of an optical distribution frame with a removal top cover according to one or more aspects described herein.

FIGS. 36-40 are diagrams illustrating different views of an optical distribution frame according to one or more aspects described herein.

FIGS. 41 and 42 are diagrams illustrating a process of installing fiber optic cable in a building using a fiber blowing system and an optical distribution frame according to one or more aspects described herein.

FIG. 43 is a flowchart showing a method for installing fiber optic cable in a building according to one or more aspects described herein.

FIG. 44 is a diagram illustrating a ferrule catcher according to one or more aspects described herein.

FIGS. 45 and 46 are perspective views illustrating how a ferrule may be connected to a ferrule holder.

FIG. 47 is a perspective view of the optical distribution frame of FIG. 34 in conjunction with an illustrative multi-output power supply unit, both coupled in an illustrative manner to an optical/electrical delivery system.

FIG. 48 shows a detailed cross section of the optical/electrical delivery system of FIG. 47.

### DETAILED DESCRIPTION

The various aspects described herein may be embodied in various forms. The following description shows by way of illustration of various embodiments and configurations in which the aspects may be practiced. It is understood that the described embodiments are merely examples, that other embodiments may be utilized, and that structural and functional modifications may be made, without departing from the scope of the present disclosure.

### Local Optical Network and Service Aggregation Gateway

As will be described, a local optical network may be provided in a building or other local area. Various services originating from outside the building or within the building may be provided to or via the local optical network, such as cable television, Internet service, telephone service (or their combinations, the so-called “triple play” service), home security video monitoring, home video server functions, and/or home automation. Although these services may be provided as optical and/or electrical signals to the local optical network, the signals may all be converted to a single type of signal—optical—so that they may all be distributed by the local optical network. The user of such a local optical network may provide superior performance over traditional copper networks. The average house in the U.S. is wired with copper that in some areas is able to transfer about 1.5 megabytes of bandwidth. However, with the installation of a local optical network, the bandwidth capacity may be virtually unlimited.

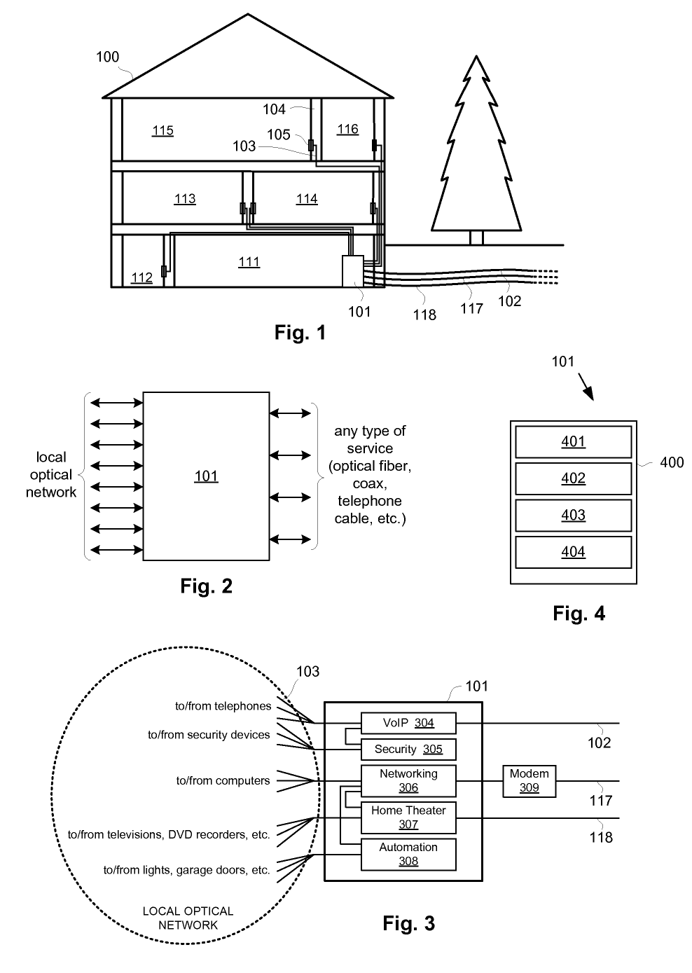

Referring to FIG. 1, an illustrative human-habitable building 100 is shown. Building 100 may be a residential building such as a single-family home, duplex, or apartment building, or it may be a non-residential building such as an office building or warehouse. Building 100 may have one or more human-habitable rooms, such as rooms 111, 112, 113, 114, 115, and 116, on one or more vertically differentiated levels. Each room may be fully or partially separated from each other by one or more walls. Doors, windows, and/or other openings may be included in the various walls. Rooms 115 and 116, for example, are separated from each other by at least wall 104. Since FIG. 1 is a cross-sectional view, other walls that are not shown may exist between the various rooms. In addition, rooms at different height levels may be partially or fully separated from each other by a floor/ceiling. The average person is familiar with standard building layouts having multiple rooms and levels.

Building 100 also includes a unit of electronic equipment 101, which will be referred to herein as a service aggregation gateway (SAG). SAG 101 may aggregate any number of services, such as telephone, cable television, internet, satellite television/data, etc., onto a local optical network. The local optical network may be located, for example, within building 100. SAG 101 may be located in any room of building 100, in any other location in building 100 such as within a wall, or even externally to building 100, such as mounted on or near an external wall of building 100. In the particular example shown, SAG 101 is located in room 111, which happens to be a basement room. Alternatively, a collection of buildings (such as a campus), including building 100, may be serviced by the same SAG 101 and may even share the same local optical network.

SAG 101 may have one or more unidirectional or bidirectional signal paths to one or more locations outside of building 100 for accessing the various services. For instance, one or more cables 102, 117, 118 or other lines are shown connecting SAG 101 with a location exterior to building 100. Cables 102, 117, 118 may extend above ground or, as shown, below ground. The various services may be provided optically and/or electrically. Where a service is provided electrically, the associated cable(s), such as cable 102, may be configured as appropriate to conduct electrical signals (i.e., current and/or voltage) along one or more electrically conductive wires. Where a service is provided optically, the associated cable(s), such as cable 117, may include one or more optically conductive signal paths such as one or more standard optical fibers. Regardless of whether a service is provided electrically or optically, SAG 101 may convert, as appropriate, all services to optical form onto the above-mentioned local optical network.

SAG 101 may further have one or more unidirectional or bidirectional optical signal paths to one or more locations within building 100. This collection of optical signal paths may embody the above-mentioned local optical network. The signal paths may be, for example, optical fiber. For instance, in the present example, SAG 101 is connected to a user node unit 105 of the local optical network at wall 104 by an optical fiber 103. Each room may have one or more user node units such as user node unit 105. Each user node unit may include a wall module and a universal outlet frame, both of which will be discussed in detail later in this description. The wall module may have one or more electrical and/or optical connectors that are accessible to a user in room 115 and that may provide data and/or power to devices that are plugged into these connectors.

As shown, SAG 101 is also connected via the local optical network to various other user nodes in building 100. In this example, a different dedicated optical fiber connects SAG 101 to each different user node. In this case, wherein SAG 101 at the center of the local optical network. Such a network topology is known as a hub-and-spoke, or star, topology. However, other network topologies may be implemented, such as a ring topology where the various user nodes are connected in series. Regardless of the local optical network topology, in this example the local optical network is connected to one or more service providers via SAG 101 and cables 102, 117, 118.

Referring to FIG. 2, SAG 101 receives any type of service in any type of format, such as optical signals (e.g., via optical fiber) and/or electrical signals (e.g., via coaxial cable, standard copper telephone cable, etc.) and coverts all services to a common format—optical—for use within building 100. All connections are shown as bi-directional connections, however one or more of the connection may be uni-directional. In addition, where a bi-direction connection is used, this connection may be embodied by a single bi-directional optical fiber or by a pair of opposing uni-directional optical fibers. The optical fibers in the local optical network may be single mode or multi-mode fiber. Either way, optical fiber has tremendous capacity as compared with copper, and so any one or more of the services may be provided on any of the optical fibers, and likely with bandwidth to spare. Moreover, different services may be multiplexed into a single optical fiber, such as by using a different wavelength for each service. For example, video and bi-directional Internet signals (including telephony functions) may be combined as a triple-play service at optical wavelengths of 1310 nm, 1490 nm, and 1550 nm using known wavelength division multiplexing (WDM) techniques, such as DWDM (dense WDM) and/or CWDM (coarse WDM). These WDM techniques may allow for even more services or other signals to be integrated, such as high-definition multimedia interface (HDMI) signals, security video camera signals, and the like. By implementing multiplexing, various different services may be simultaneously provided on any given optical fiber of the local optical network. Where the signals are bi-directional within the same optical fiber, signals in one direction may use a particular frequency or set of frequencies, and signals in the opposing direction may use a different particular frequency or set of frequencies, to reduce reflection interference.

Referring to FIG. 3, an illustrative functional block diagram of SAG 101 is shown. SAG 101 may include one or more units, such as a voice-over-Internet-Protocol (VoIP) unit 304, a security unit 305, a network unit 306, a home theater unit 307, and/or an automation unit 308. Other types of units and other functions may alternatively or additionally be included in SAG 101. Each of units 304-308 may further be connected to one or more other devices in building 100 via optical fiber (such as optical fiber 103) making up the local optical network. Some or all of units 304-308 may include one or more receivers for receiving incoming signals from one or more services external to building 100 and/or from the optical network within building 100. Also, some or all of units 304-308 may include one or more transmitters for sending signals onto the optical network and upstream to one or more services. The receivers and/or transmitters may be considered individual units and/or shared as a single large receiver and/or transmitter or a grouped bank of receivers and/or transmitters.

VoIP unit 304 provides VoIP telephone functionality by coordinating telephone calls among telephones within building 100 as well as calls to/from external telephone networks (outside of building 100), such as landline telephone networks or cellular telephone networks.

Security unit 305 provides security functionality by monitoring and controlling sensors associated with building and perimeter security. Security unit 305 may further communicate with an external telephone service provider, such as via VoIP unit 304 or directly with the external telephone service provider, to alert a security company or the authorities of security incidents.

Networking unit 306 provides data networking functionality within building 100. In particular, networking unit 306 may provide access by any device in building 100 to one or more external networks such as the Internet (e.g., via a service provider) and/or one or more internal networks such as a wired or wireless LAN. Networking unit 306 may include or be connected to a modem 309, such as a cable modem, dial-up modem, optical fiber modem, etc., to communicate with the external networks.

Home theater unit 307 provides home theater functionality such as audio and/or video presentations. Home theater unit 307 may be connected by optical fiber to one or more audio/video presentation devices located in building 100, such as home stereo equipment, televisions, computers, movie projectors, speakers, video game equipment, and the like.

Automation unit 308 provides home automation functionality by coordinating and controlling various devices in building 100. Automation unit 308 may control, for example, room lighting, door locks, heating/cooling units, etc. In addition, automation unit 308 may exercise control over, or otherwise work in conjunction with, devices also controlled by the other units 304-307. For instance, automation unit 308 may turn lights on in a portion of building 100 where security unit 305 has detected a security breach. In fact, any of units 304-308 may communicate with each other as appropriate. Such communication may be through direct connections or indirectly, such as via distributor 303.

FIG. 4 is a front view of an example of SAG 101. In the shown example, SAG 101 is housed in a rack 400 into which one or more rack units 401-404 may be mounted. Thus, SAG 101 in this example includes rack 400 and the various rack units 401-404 mounted in rack 400. Rack 400 may be configured to accept any size rack units such as standard nineteen-inch-wide rack units, and may be tall enough to accept several rack units at a time, such as four or more rack units stacked vertically with respect to each other. Such generic rack configurations are well known and are typically used for mounting multiple pieces of computer equipment. In such rack configurations, wires and other lines may be run among the various mounted rack units, typically via connectors in the rear and/or front of each rack unit. In such a case, the lines may run within the enclosed space of rack 400 itself, behind the rack units, and/or in front of the rack units. Any lines running externally to/from rack 400 may be made via openings in the rear or bottom of rack 400, for example.

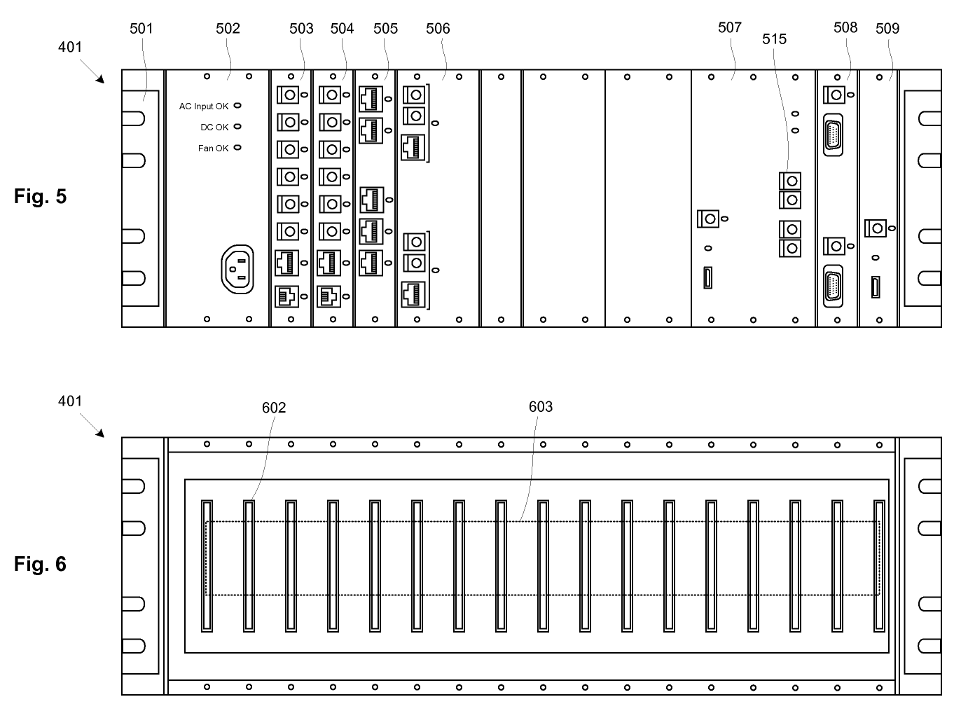

FIG. 5 is a front view of an example of representative rack unit 401, however FIG. 5 may be considered to represent any of rack units 401-404. As shown, rack unit 401 has a pair of mounting brackets 501 on the left and right sides, which are configured to allow rack unit 401 to mount securely to a desired vertical level in the rack of SAG 101. In this example, the rack may have a series of threaded holes for accepting threaded bolts, and the bolts may extend through holes or other openings in mounting brackets 501. When the bolts are tightened, they act to clamp mounting brackets 501 against the rack itself.

Rack unit 401 as shown includes a horizontal series of threaded holes at the top and bottom of rack unit 401, into which screws may be inserted to mount various sub-units. In the shown example, sub-units 502, 503, 504, 505, 506, 50, 508, and 509 are mounted to rack unit 401, along with several blank cover plates mounted between sub-units 506 and 507. The sub-units that are mounted to rack unit 401 may be easily changed simply by mounting and unmounting the sub-units. Each sub-unit may have a width that is a whole multiple of a predetermined minimum width, so as to allow for a wide variety of sub-unit combinations to be mounted in rack unit 401. For instance, in the shown example, sub-unit 502 has a width that is three times the width of sub-unit 503, and sub-unit 506 has a width that is twice the width of sub-unit 503. In this example, the predetermined minimum width may be the width of, for instance, sub-unit 503.

Various combinations of sub-units may be arbitrarily mounted in rack unit 401 as desired as and space allows, depending upon the function(s) desired to be provided by rack unit 401. In the shown example, sub-unit 502 is a power supply for controlling and supplying power to the other sub-units. For instance, 110 or 220 volt power may be provided. In addition, sub-unit 502 may include one or more fans for ventilation. Sub-units 503 and 504 are each a switch, such as an Ethernet switch, for switching incoming signals received via various connectors to appropriate outgoing connectors. Sub-unit 505 is a router, such as an Ethernet router, for routing incoming signals received via various connectors to appropriate outgoing connectors. Sub-unit 506 is a video server support card that allows local control and monitoring of rack unit 401 and/or entire SAG 101. Sub-unit 507 is a high-definition television (HDTV) card, and sub-unit 508 is a standard cable television (CATV) card. These sub-units 507, 508 receive television signals and process them as appropriate, such as by extracting and/or descrambling the television signals.

The above combination of sub-units is merely an example; any combination may be used of the above-mentioned sub-units and of any other sub-units. Relating the use of physical sub-units and rack units to FIG. 3, each of the functional units 304-308 may be implemented within an individual rack unit or among a combination of rack units, as well as by an individual rack sub-unit or a combination of rack sub-units. The sub-units described with reference to FIG. 5 are merely examples, and other types of sub-units may be added to a rack unit.

Referring to FIG. 6, representative rack unit 401 may include a series of connectors, such as connector 602, to which the various sub-units may be connected. These connectors may be electrical and/or optical connectors and may be electrically and/or optically connected to each other in any manner desired. The connectors, such as connector 602, allow the various sub-units to communicate with other sub-units in the same rack unit or in a different rack unit. Each of these connectors may be capable of handling large bandwidth data streams, such as a gigabit per second or more.

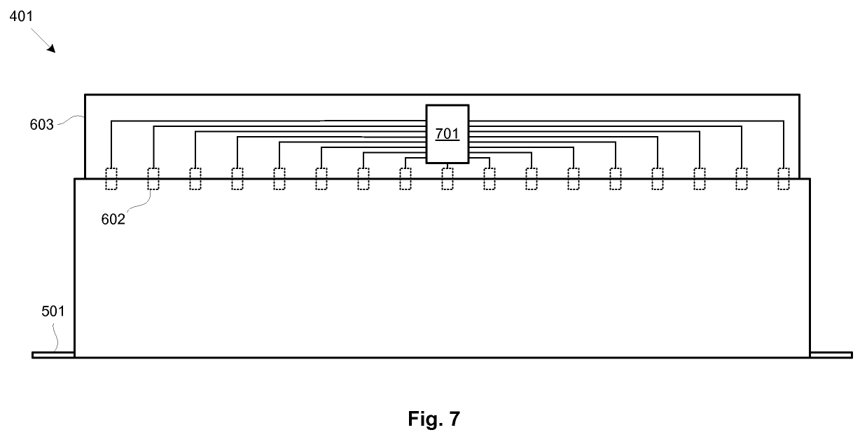

In addition, as shown in FIG. 7, each rack unit (such as rack unit 401) may have a controller 603, which may be disposed at the rear of each rack unit, that controls and coordinates communication between the various sub-units in that rack unit. Controller 603 may include circuitry 701 that implements and controls an RS-485 multi-drop network to provide for such inter-sub-unit communication. In an RS-485 network, up to thirty-two driving units and thirty-two receiving units may communicate with each other over a common cable, such as a twisted-pair electrical cable.

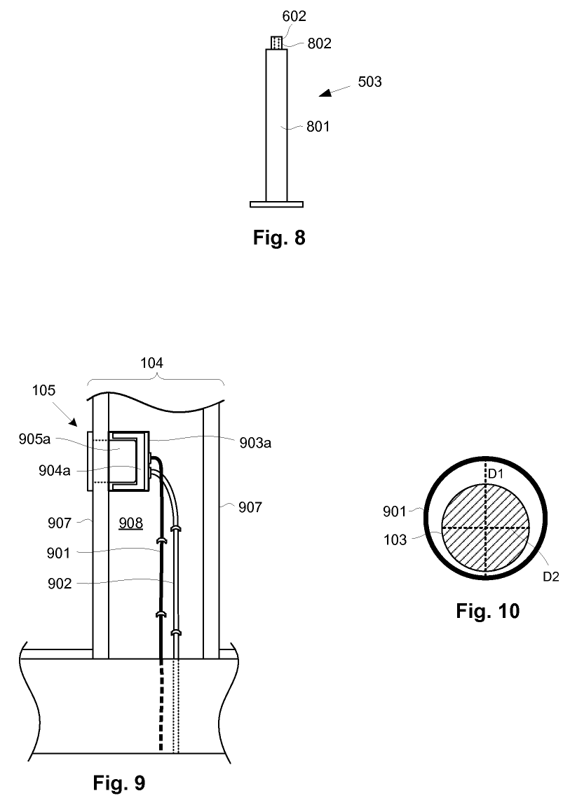

Referring to FIG. 8, each sub-unit, such as sub-unit 503, may include one or more circuit cards 801 (such as standard circuit boards) with one or more connector 802 disposed on the end of one or more of the circuit cards 801. Connector 802 electrically and/or optically mates with one or more of the sub-unit connectors of rack unit 401, such as connector 602.

### Modular Local Optical Network Units

Assuming that the local optical network is installed in building 100, users will need to access the local optical network at one or more user nodes. These user node units may include a variety of different types of wall modules that can interchangeably plug into universal outlet frames. Thus, at each node of the optical network in each room of building 100, one or more universal outlet frames may be installed. At any time, even later, such as after the building becomes occupied, the user may decide to install particular types of wall modules as desired. Thus, there is no need to pre-determine the function and application of a particular network node during the building construction or retrofitting stage. The user can also dynamically change these wall modules at any time as needed. For instance, if a particular node in the network for a particular room is desired to have television, then a cable television wall module having a coaxial electrical connector may be plugged into the universal outlet frame for that node. Later, if instead an Internet connection is desired at that node, then the original wall module may be removed and replaced with an Internet wall module. Each wall module may receive optical signals and, using received electrical power (both received via the universal outlet frame), convert the incoming optical signals to electrical signals for use by the user, and vice-versa for outgoing electrical signals. Thus, the fact that the local network is a local optical network may be transparent to the user of conventional electrical-signal-based equipment. It is noted that the term “wall module” is not intended to limit these modules to being used in conjunction with a wall. For instance, the wall modules may be plugged into a floor of the building 100 or into any other element that is or is not part of the building 100.

Referring to FIG. 9, an illustrative cross-sectional view of wall 104 is shown including a representative connection of the local optical network to a room or other region in building 100. As shown in this example, wall 104 may define a hollow space that is at least partially, if not fully, enclosed by a wall covering 907 on either side of wall 104, such as standard drywall or other wallboard. Alternatively, wall 104 may be a hardened wall such as a concrete block wall, in which one or more hollow spaces are formed within the concrete block wall. Such hollow spaces may be formed due to the hollow shape of the concrete blocks, for example. Other examples of hollow spaces formed within walls, floors, and ceilings may include, for instance, risers, cable trays, ducts, and the like. Such wall configurations, and variations thereof, are typical of most buildings.

In the shown example, a wall module 905a is disposed at least partially in the hollow space of wall 104 and is connected to a user node of the optical fiber network. Wall module 905a is attached to a universal outlet frame 904a, which in turn is attached to a mount 903a, which in turn is attached to a structure of building 100 such as a vertical stud 908 and/or to wall covering 907. Mount 903a may be any type of structure that helps to maintain the position of and provide structural support to universal outlet frame 904a, and may be a bracket, box, housing, or any other appropriate attachment structure. For example, mount 903a may be a standard electrical box normally configured to house conventional home electrical receptacles (also commonly known as electrical outlets). Such electrical boxes are presently available at nearly any hardware store and are already installed in the walls of most conventional buildings. As will be described further, universal outlet frame 904a provides signals to and/or from wall module 905a.

One or more optical fibers may be provided to and terminate at mount 903a. Each of the optical fibers may extend through its own individual elongated conduit 901, which may run loosely through the hollow space of wall 104 and/or be attached to one or more structures within the hollow space, such as to stud 908 as shown. In addition to the optical fibers, one or more electrical cables 902 may also run loosely through the hollow space of wall 104 and/or be attached to one or more structures, such as to stud 908 as shown. Thus, mount 903a may receive both optical fibers and electrical cables as desired.

FIG. 10 is an illustrative cross-sectional view showing optical fiber 103 running within conduit 901. Conduit 901 has an inner diameter D1 and optical fiber 103 has an outer diameter D2, which includes the core, cladding, and any coating or other outer layers. Although diameters D1 and D2 may be of any relative sizes, these diameters may be close to each other in size. For instance, it may be desirable that the inner diameter D1 of conduit 901 be no more than twice the outer diameter D2 of optical fiber 103. Also, it may be desirable that the inner diameter D1 of conduit 901 be no more than three, two, or even one millimeter greater than the outer diameter D2 of optical fiber 103.

These relationships between diameters D1 and D2 provide for a small amount of clearance between optical fiber 103 and conduit 901, which in turn may provide for easier blowing of optical fiber 103 through conduit 901. This reduced clearance may allow optical fiber 103 to catch more of the air being used to blow optical fiber 103 through conduit 901, and also may reduce the possibility of optical fiber folding, catching, or otherwise excessively bending within conduit 901 during blowing, especially at locations where conduit 901 may bend.

Conduit 901 may be made of any material and may be flexible or stiff. In one example, conduit 901 may be made of polyvinyl chloride (PVC) and may be considered a relatively small micro-duct. Conduit 901 may, for instance, have an inner diameter D1 of approximately 3.5 millimeters in diameter or smaller and optical fiber 103 may have an outer diameter D2 of approximately 0.9 millimeters or larger. Other examples of size ranges include D1 being in the range of about 3 millimeters to 6 millimeters and D2 being in the range of about 2 millimeters to 4 millimeters. However, these are merely examples, and other combinations of D1 and D2 are possible. These particular size ranges and material for such a conduit may result in a flexible conduit that can easily bend around corners while still maintaining structural strength and protecting the optical fiber therein. In addition, due to the potential flexibility gained from using such a relatively small diameter, conduit 901 may be transported on and fed into an existing wall from a circular reel. Although conduit 901 is shown as having a circular cross section, it may have any cross-sectional shape desired, such as oval. Where the cross section of a conduit is not circular, the “inner diameter,” as used herein, of that conduit is the diameter of the largest imaginary circle that can be placed completely within the cross section of the conduit. Thus, for any shape of conduit, the inner diameter of a conduit would be the largest diameter of optical fiber that can be run through the conduit.

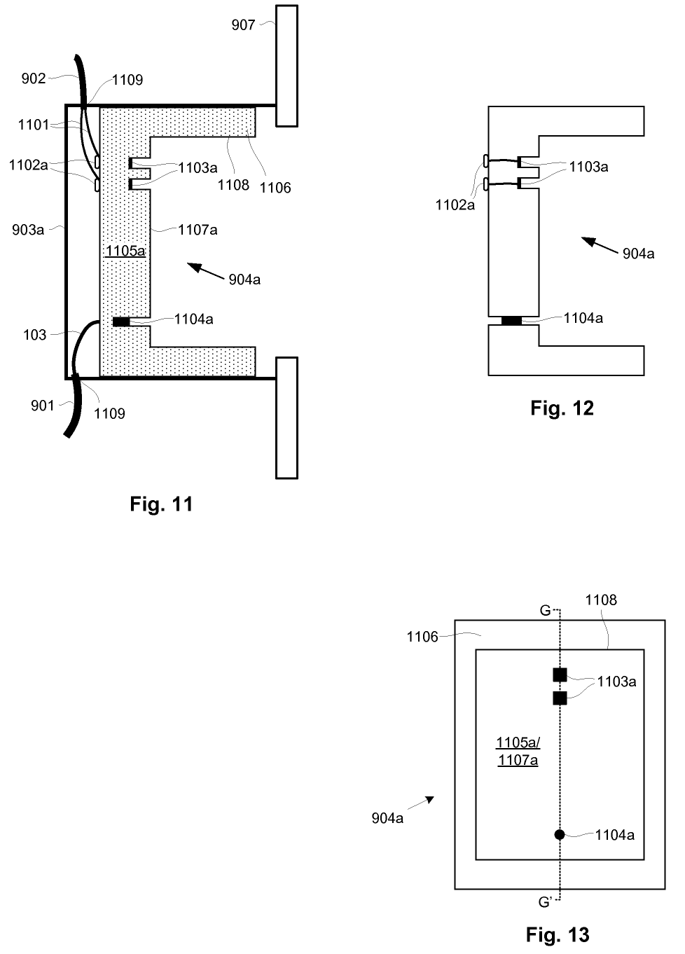

Referring to FIGS. 11 and 12, illustrative cross-sectional views of universal outlet frame 904a are shown. Universal outlet frame 904a may be used to provide an interface between wall module 905a and the optical fibers of the local optical network in building 100, such as optical fiber 103. Also, as will be described later, universal outlet frame 904a may be used to interface with a variety of different types of wall modules without necessarily having to reconfigure universal outlet frame 904a.

Universal outlet frame 904a in this example has a body that may be attached to mount 903a, such as using screws or other attachment hardware (not shown). As shown, the body of universal outlet frame 904a has a main region 1105a and lateral opposing regions 1106 extending generally perpendicularly from main region 1105a at two or more ends. Main region 1105a has a surface 1107a that runs generally parallel to wall covering 907 when universal outlet frame 904a is properly attached to mount 903a. As shown, an opening in wall covering 907 is provided such that surface 1107a faces the opening. As will be described, this may allow a wall module to slide through the hole in wall covering 907 and plugged in to universal outlet frame 904a. Surface 1107a has a plurality of holes or other openings in which various connectors for optical and/or electrical signals may reside. In this example, electrical connections (such as electrical contact pads or plugs) 1103a, as well as an optical connector 1104a, reside in such holes. Alternatively, some or all of the connectors 1103a, 1104a may be mounted on surface 1107a directly without residing in a hole. In either case, connectors 1103a, 1104a may partially or fully extend outward from surface 1107a, or they may reside completely within their respective holes as shown. In other examples, such connectors and any associated holes may alternatively or additionally reside in and/or on a surface 1108 of lateral region 1106, which in this example runs generally perpendicularly to wall cover 907 when universal outlet frame 904a is properly attached to mount 903a.

As can be further seen in FIG. 11, electrical cable 902 and/or its wires 1101 may pass through one or more openings 1109 in mount 903a, and wires 1101 may be electrically connected to connectors 1103a such as via electrical contacts 1102a (e.g., metal screws). Also, conduit 901 and/or optical fiber 103 may pass through one or more openings 1109 in mount 903a, and optical fiber 103 may be optically connected to connector 1104a. Both electrical wires 1101 and optical fiber 103 may be used to transfer signals. However, as will be described further, it may be desirable to provide power via wires 1101 and signals via optical fiber 103, where the electrical power transferred by wires 1101 may be used to convert optical signals to electrical signals and vice-versa.

FIG. 13 shows a face view of universal outlet frame 904a (as viewed from the right hand side of FIGS. 11 and 12). In this example, connectors 1103a and 1104a are arranged in a particular layout with respect to the expanse of surface 1107a. However, such connectors may be arranged in any layout desired.

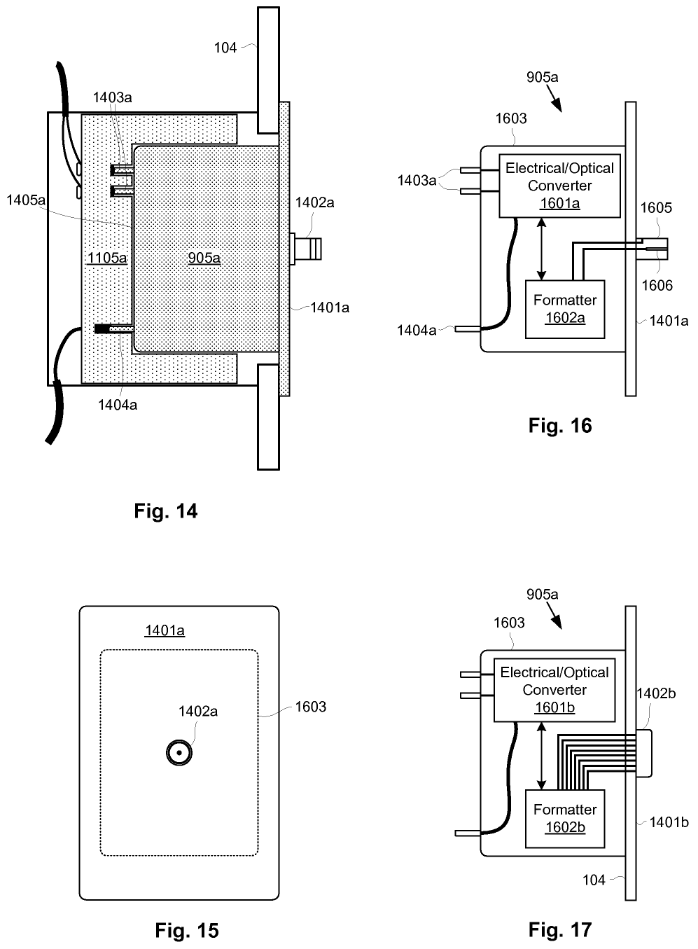

FIG. 14 is an illustrative side view of wall module 905a when attached to universal outlet frame 904a. Wall module 905a has one or more electrical connectors 1403a and/or optical connectors 1404a that may be configured and arranged to interface and connect with appropriate connectors 1103a, 1104a of universal outlet frame 904a. For instance, in the shown example, the layout (i.e., positioning) of connectors 1403a, 1404a on a rear surface 1405a of wall module 905a is a mirror image of the layout of connectors 1103a, 1104a on surface 1107a. In this way, wall module 905a may be plugged in to universal outlet frame 904a through the hole in wall 104, such as by longitudinally sliding wall module 905a toward universal outlet frame 904a and applying force to press them together such that their respective connectors 1403a, 1404a, 1103a, 1104a align and mate. In the shown example, connectors 1103a, 1104a of universal outlet frame 904a are female-style connectors and connectors 1403a, 1404a of wall module 905a are male-style connectors. However, the styles of the connectors may be reversed or modified in any manner desired. Regardless of the styles of connectors used, it may be desirable that connectors 1403a electrically mate with connectors 1103a, and that connector 1404a optically mates with connector 1104a, upon properly attaching wall module 905a to universal outlet frame 904a.

As shown in FIG. 14, wall module 905a also has a removable cover plate 1401a and a user connector 1402a on the opposite side of wall module 905a as connectors 1403a, 1404a. Cover plate 1401a may be sized to conceal the opening in wall covering 907. Also, cover plate 1401a may have one or more holes or other openings through which connector 1402a may extend. To install cover plate 1401a, the main body of wall module 905a may be plugged in to universal outlet frame 904a, and then cover plate 1401a may be attached to the main body of wall module 905a, to universal outlet frame 904a, and/or to wall 104.

User connector 1402 may be any type of electrical and/or optical connector. For instance, FIGS. 14 and 15 illustratively show user connector 1402a as being a standard electrical type F connector that may be connected to, for example, RG-59 coaxial electrical cable. However, any other type of connectors may be used, such as but not limited to a standard telephone connector, an RJ-45 Ethernet connector, a standard RJ-11 telephone jack, a bayonet-mount connector such as a BNC connector, a HDMI connector, a digital video interface (DVI) connector, a universal serial bus (USB) connector, an S-video connector, a DIN connector, an RCA jack, a headphone jack, a speaker wire binding post, a banana plug receptacle, a lug terminal, a D-subminiature connector, and/or an optical connector, including any combination and quantity of these.

Referring next to FIG. 16, an illustrative functional block diagram is shown in which wall module 905a has an electrical/optical converter 1601a and a formatter 1602a disposed at least partially in a housing 1603. Housing 1603 may be sized and shaped to fit partially or entirely within mount 903a (especially where mount 903a is an electrical outlet box) and/or within universal outlet frame 904a when plugged into universal outlet frame 904a. In addition, housing 1603 may have a surface that, when wall module 905a is plugged into universal outlet frame 904a mate with one or more of surfaces 1107a, 1108 of universal outlet frame 904a.

Electrical/optical converter 1601a converts optical signals to electrical signals and/or electrical signals to optical signals, as desired. In particular, optical signals received via connector 1404a are converted to electrical signals that are output formatter 1602a, formatted to an appropriate format, and then output to user connector 1402a (where user connector 1402a is an electrical connector). In addition or alternatively, electrical signals received via connector 1404a are formatted as appropriate by formatter 1602a and passed to electrical/optical converter 1601a, which in turn converts the received electrical signals to optical signals and sends those optical signals to connector 1404a.

Formatter 1602a serves to format electrical signals to meet the requirements of the particular user connector(s) that are part of the connection module being used. The electrical signal formatting that may be performed by formatter 1602a may include, for instance, controlling the voltage and current of the electrical signals, dividing and/or merging electrical signals onto an appropriate number of electrical conductors, performing multiplexing or demultiplexing of electrical signals, and/or controlling the impedance seen at the user connector(s). However, any of these functions, such as impedance matching and voltage and current control, alternatively may be performed by electrical/optical converter 1601a. Moreover, it should be noted that the division of functions between electrical/optical converter 1601a and formatter 1602a in this example is merely functional; electrical/optical converter 1601a and formatter 1602a may be partially or fully combined as a single physical unit and/or divided in any of various ways.

Regardless of which units within wall module 905a perform which function, the type of formatting performed by wall module 905a may depend upon the type of user connector(s) provided on wall module 905a. For instance, in FIG. 16 it can be seen that formatter 1602a outputs (and receives) electrical signals to/from user connector 1402 on two electrical conductors 1605, 1606. However, in FIG. 17 it can be seen that an electrical/optical converter 1601b and a formatter 1602b outputs (and receives) electrical signals to/from a user connector 1402b on eight electrical conductors, wherein user connector 1402b is accessible through an opening in a cover plate 1401b.

Although the front user connectors 1402, 1701, etc. may vary from wall module to wall module, each wall module may be configured to have the same interfacing configuration, e.g., the same size and shape housing 1603, the same rear connector 1403a, 1404a configuration (e.g., positioning and/or types of connectors, etc.), and/or the same signal/power requirements. This standard interfacing configuration means that the various wall modules (e.g., a phone jack wall module, a coaxial cable television wall module, etc.) will interface with universal outlet frame 903a in the same way and thus may be interchangeable such that all of the various wall modules can plug into the same universal outlet frame 903a without reconfiguration of universal outlet frame 903a. Because a standard interfacing configuration may be provided for each wall module, a kit or other system may be marketed or otherwise provided that contains one or more universal outlet frames and a plurality of different wall modules each configured to interchangeably interface with the universal outlet frames.

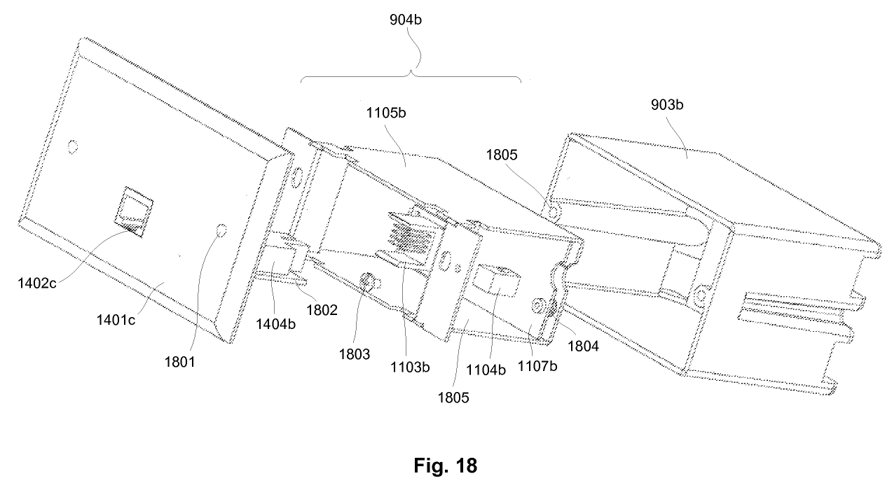

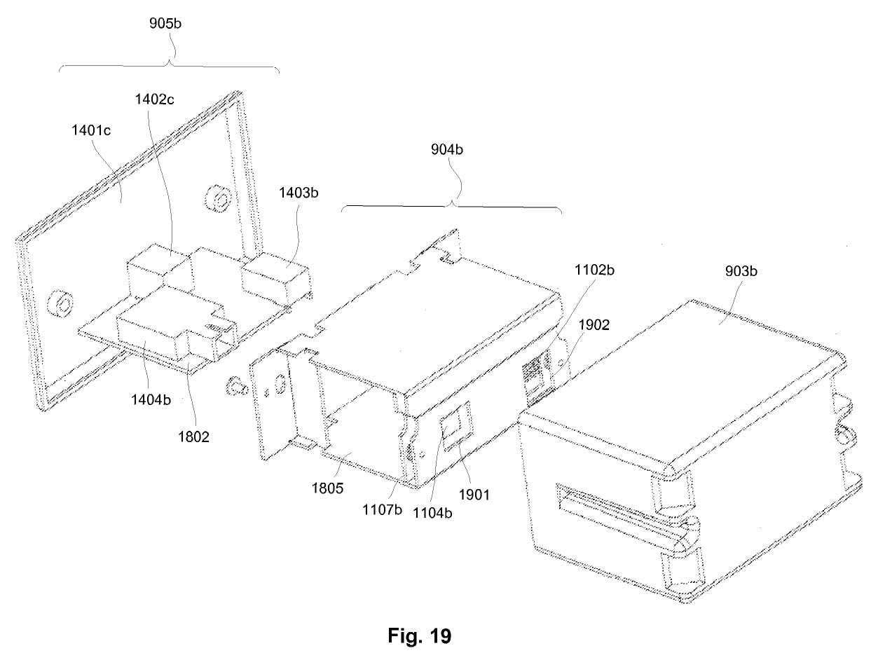

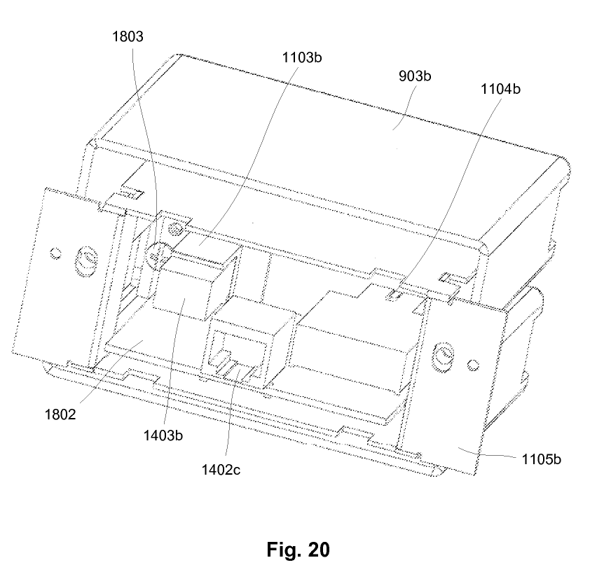

Another example of a wall module and universal outlet frame pair is shown in FIGS. 18, 19, and 20. Referring to the exploded views of FIGS. 18 and 19, a user node unit is shown having a mount 903b in the form of a standard blue plastic electrical outlet box, a universal outlet frame 904b, and a wall module 905b that is pluggable into universal outlet frame 904b. Since electrical outlet box configurations may differ among different countries or other regions, the universal outlet frame 904b may likewise be configured so as to properly attach to the appropriate type of electrical outlet box.

Universal outlet frame 904b has a frame or body 1105b supporting an electrical connector 1103b and an optical connector 1104b, which are each mounted to and extend inwardly from an inner plate 1107b. A pair of screws 1803 and springs 1804 are provided between body 1105b and inner plate 1107b to absorb forces applied by plugging wall module 905b into universal outlet frame 904b. Universal outlet frame 904b may be attached to mount 903b (which in this example is an electrical outlet box) with a pair of screws (now shown) in standard screw holes 1805 drilled into electrical outlet box 903b. Universal outlet frame 904b also has another electrical connector 1102b that extends rearwardly and performs the same function as electrical contacts 1102a of FIG. 11. Optical connector 1104b is accessible to optical fiber 103 through an opening 1901 in the rear of body 1105b, and electrical connector 1102b is accessible to wires 1101 (and/or a connector, not shown, at the end of wires 1101), through an opening 1902 in the rear of body 1105b.

Wall module 905b has a removable cover plate 1401c that is removably attachable to body 1105b of universal outlet frame 904b with screws (not shown) through a pair of holes 1801. In addition, a platform 1802 such as a standard circuit board is provided to support a combined optical connector, electrical/optical converter, and formatter 1404b, as well as an electrical connector 1403b and a user connector 1402c. In this example, user connector 1402c is an RJ-11 telephone jack. The various units 1402c, 1403b, and 1404b may be interconnected as appropriate, such as via conductive paths patterned in and/or on platform 1802. Electrical connector 1403b performs the same function as electrical connectors 1403a in FIG. 16, and unit 1404b performs the functions of optical connector 1404a and both units 1601a and 1602a in FIG. 16. In addition, some of the formatting and/or converting functionality may be performed by circuitry (not shown) on platform 1802 or elsewhere in wall module 905b.

Electrical connector 1103b of the universal outlet frame and electrical connector 1403b of the wall module are configured so as to electrically mate with each other (e.g., a matched male/female pair). Also, optical connector 1104b of the universal outlet frame and the optical connector of unit 1404b are configured so as to optically mate with each other (e.g., a matched male/female pair). Thus, electrical connector 1103b performs the same function as electrical connectors 1103a in FIG. 11, and optical connector 1104b performs the same function as optical connector 1104a in FIG. 11.

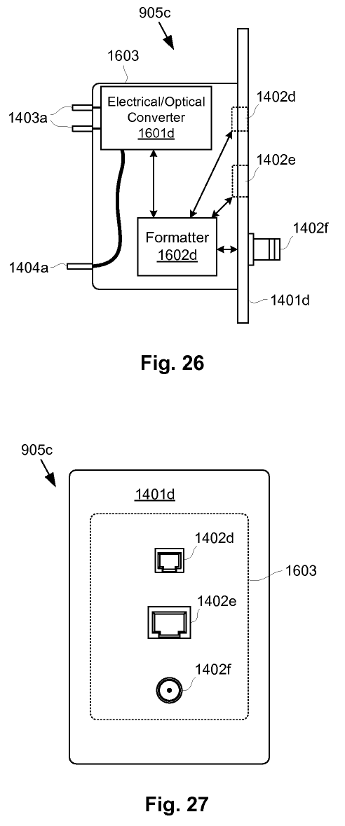

Yet another example of a modular outlet system is shown in FIGS. 26 and 27, in which multiple services are provided via the same wall module. In this example, a wall module 905c provides triple-play service. That is, wall module 905c provides Internet, telephone, and television service simultaneously. To do this, an electrical/optical converter 1601d and a formatter 1602d are provided that convert incoming optical signals (via optical connector 1404a) into electrical signals, which are formatted and distributed as appropriate as a “plain-old-telephone system” (POTS) signal to an RJ-11 user connector 1402d, as a digital data signal to an Ethernet RJ-45 user connector 1402e, and as an analog television signal to a coaxial user connector 1402f. In addition, any upstream electrical signals sent from the various user connectors 1402d, 1402d, 1402f may be converted to appropriate optical signals sent into the optical network via optical connector 1404a.

### Keyed Optical Fiber Ferrule and Ferrule Holder

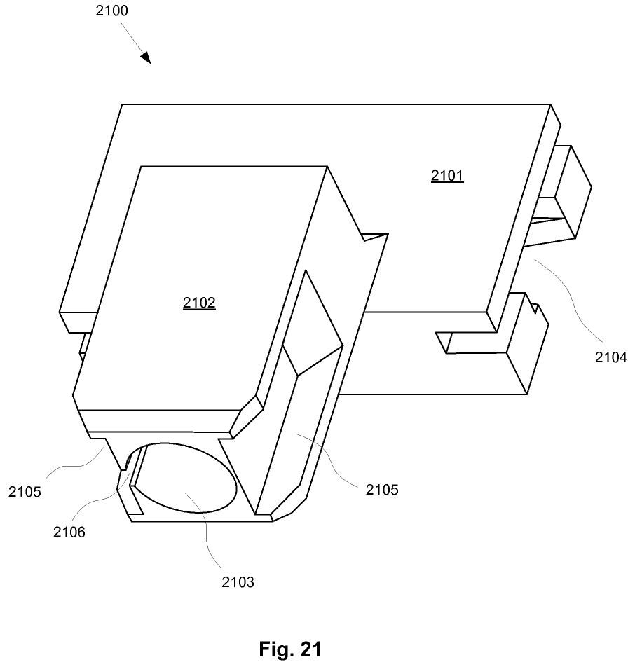

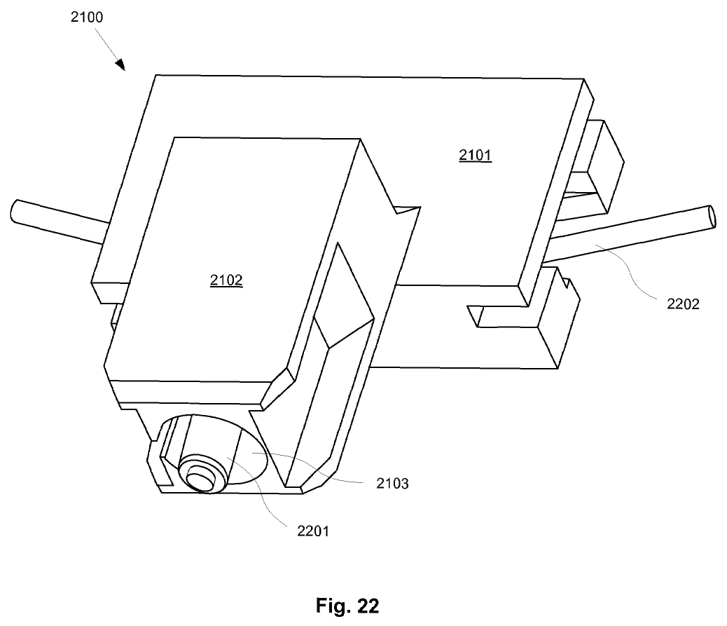

Referring to FIG. 21, the universal outlet frame optical connector 1104a or 1104b may be embodied as or include a ferrule holder 2100 for holding an optical fiber ferrule 2201 (FIG. 22) of optical fiber 103. In the shown example, ferrule holder 2100 includes a first body portion 2101 connected to a second body portion 2102. First body portion 2101 is configured to connect to universal outlet frame 904a or 904b, such as to surface 1107a or inner plate 1107b. First body portion 2101 may include a region 2104 configured to receive and hold a spring 2202 (FIG. 22), such as a leaf spring. Spring 2202 may help absorb any pressure exerted during seating of ferrule 2201 into ferrule holder 2100 and may be mounted to, for example, floor 1805 of universal outlet frame 904b in the example of FIG. 18. In such a case, ferrule holder 2100 may function as optical connector 1104b.

Second body portion 2102 includes an opening 2103 that extends fully through first and second body portions 2101 and 2102, for receiving optical fiber 103 and its ferrule 2201. Second body portion 2102 also includes a slot 2106 running parallel to an on one side of opening 2103. Slot 2106 may extend the entire length of opening 2103 to allow optical fiber 103 to be inserted laterally into opening 2103, as shown in FIG. 22. Second body portion 2102 also includes one or more 2105 slots or other physical features appropriate for receiving a standard optical fiber connector.

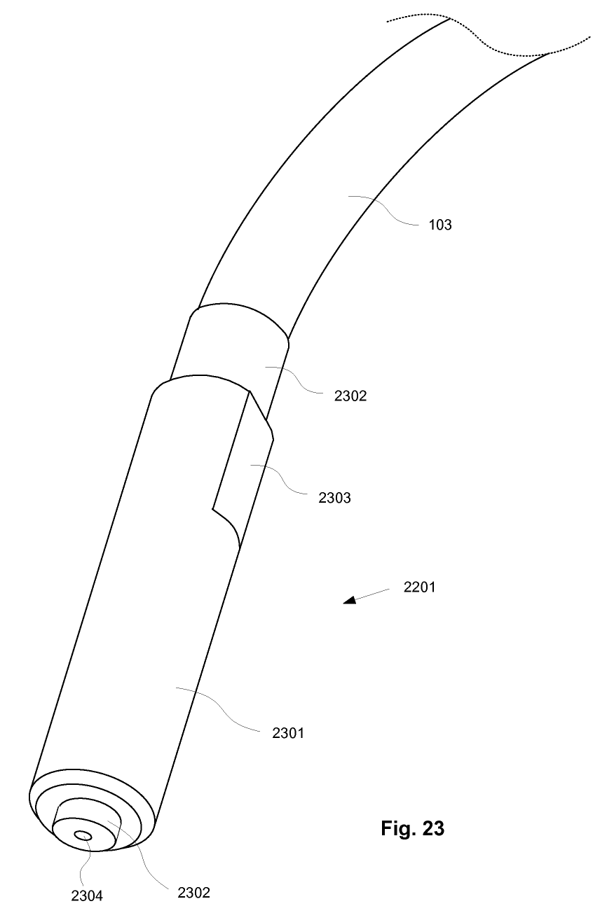

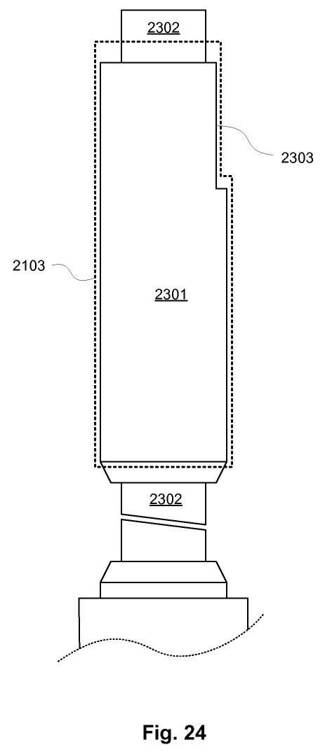

Referring to FIG. 23, ferrule 2201 includes a main body 2301 which may be elongated and that may have an outer surface that is substantially cylindrical and/or any other shape. Main body 2301 may be of a size that will fit through conduit 901. For instance, main body 2301 may have an outer diameter of approximately 2.5 mm. In addition, an inner lining 2302 such as a ceramic material may be disposed between an optically-conductive core 2304 of optical fiber 103 and main body 2301. Main body 2301 may further have a physical asymmetric anomaly such as a flattened region 2303. This anomaly may be configured to fit within a matched complementary anomaly in the shape of at least a portion of the inner surface of opening 2103, as shown in the cross section of FIG. 24. This complementary surface keying effectively allows for a keyed fit of ferrule 2201 within opening 2103 to ensure that ferrule 2201 fits only in a particular rotational/axial orientation with respect to opening 2103. For example, ferrule 2201 may have an outer surface shape, and slot 2106 may have a complementary inner surface shape, such that ferrule 2201 may fit fully within opening 2103 only in a single rotational/axial orientation with respect to opening 2103.

A reason that a keyed fit may be desirable is that optical fiber 103 may be cut and polished, to expose a tip of the optically-conductive core 2304 of optical fiber 103, at an angle. An example of this is angled cut is shown at the bottom of FIG. 24. Such an angled cut helps reduce backscattering, which may be an important consideration given a fast local optical network. Because the connection at the angle cut should match the angle of the cut of the mating optical fiber, the matching axial orientation of ferrule 2201 may be important for a good optical connection. It is noted that, after cutting, optical fiber core 2304 and inner lining 2302 may extend only a short distance from main body 2301, such as no more than three millimeters, to maintain the strength of the optical fiber near the tip.

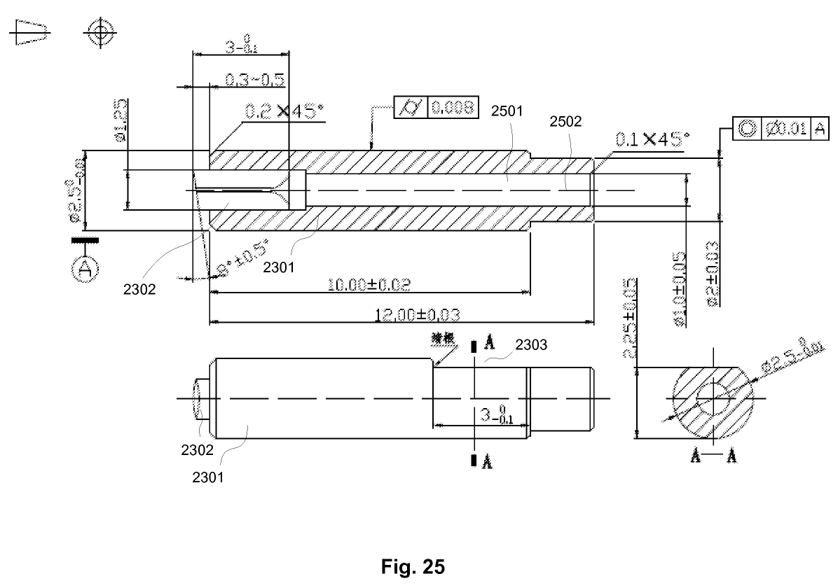

It should be further noted that flattened region 2303 is just one example of keying of ferrule 2201. Other types of physical keying may be implemented, such as one or more notches and/or raised regions, or any physical feature that is assymetrical about an imaginary axis 2502 of main body 2301 along which optical fiber 301 is threaded through a hollow channel 2501 of main body 2301 (see FIG. 25). Regardless of the way that keying is implemented, it is desirable that the keying be designed to allow only a single axial orientation of ferrule 2201 to fully fit within matching keyed opening 2103. FIG. 25 shows another view of ferrule 2201, including hollow channel 2501 extending fully through main body 2301 for receiving core 2304 of optical fiber 103 such that optical fiber 103 may extend from both opposing ends of main body 2301.

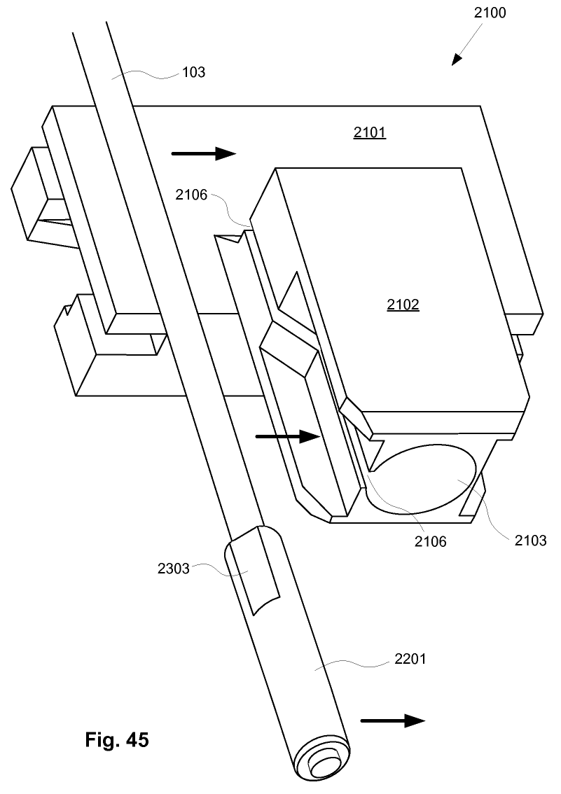

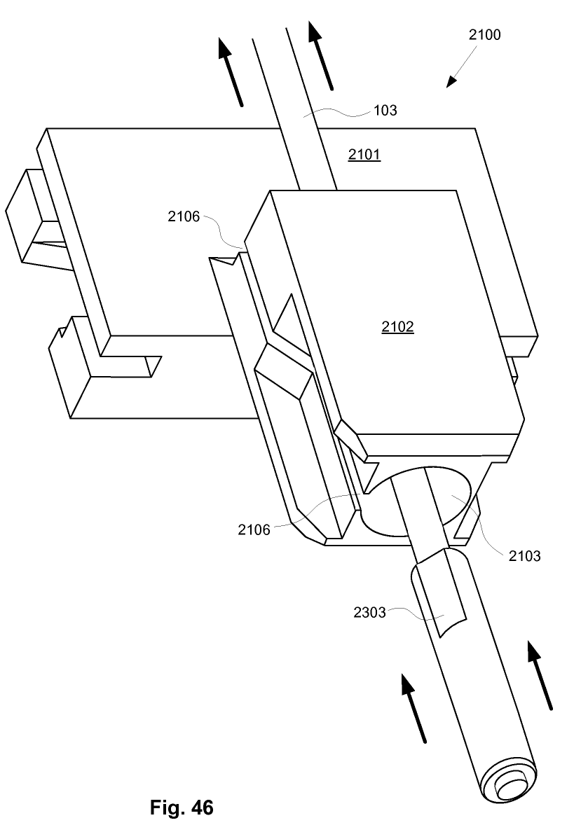

Optical fiber 103 having ferrule 2201 may be connected to ferrule holder 2100 in a variety of ways. For example, referring to FIG. 45, optical fiber 103 and ferrule 2201 may be moved laterally (in the direction of the shown arrows) toward ferrule holder 2100 such that optical fiber 103 is passed through slot 2106 into opening 2103. Then, as shown in FIG. 46, optical fiber 103 may be pulled back (in the direction of the shown arrows) such that ferrule 2201 passes into opening 2103. Due to the keying as discussed above, if ferrule 2201 is in the correct axial rotation relative to opening 2103, then ferrule 2201 will be able to be pulled fully back into opening 2103 until it is fully seated against a rear surface of opening 2103. However, if ferrule 2201 is in any other axial rotation, then ferrule 2201 will not be able to be pulled fully back into opening 2103 because the keyed physical features of ferrule 2201 and opening 2103 will not match.

To manufacture the structure of FIG. 23, optical fiber 103 may be inserted (after removing an outer portion thereof to expose core 2304 and/or other layers surrounding core 2304) into channel 2501 of main body 2301. Then, optical fiber 301 may be cut to produce a flat angled surface that is at a non-perpendicular angle to axis 2502, which is also the lengthwise axis of optical fiber 301 within main body 2301. Next, optical fiber 301 and/or main body 2301 may be rotated such that a flattened region 2303 is at a predetermined rotational angle about axis 2502 relative to the cut angled tip of optical fiber 301. Once this angle is established, optical fiber 301 and main body 2301 may be fixed together to maintain this rotational angle, such as through cement, glue, or other means. It is noted that the predetermined angle may be arbitrary but may be preferably consistent throughout a batch of ferrule/fiber combinations. Thus, using this method, optical fiber 301 and/or main body 2301 may be adjusted after cutting optical fiber 301, using flattened region 2303 as a key for determining the relative rotation between optical fiber 301 and main body 2301. Alternatively, optical fiber 301 and main body 2301 may be fixed together prior to cutting, and then flattened region 2303 is used as a key to determine at what rotational angle optical fiber 301 should be cut.

### Local Optical Network Installation

The various optical fibers of the local optical network may be installed while building 100 is being constructed, or they may be retrofitted within the walls after the building is constructed. In either case, the various optical fiber conduits may be installed within the walls and then the optical fibers may be blown through the conduits. Various illustrative techniques and equipment used in connection with installing and managing the optical fibers are now described.

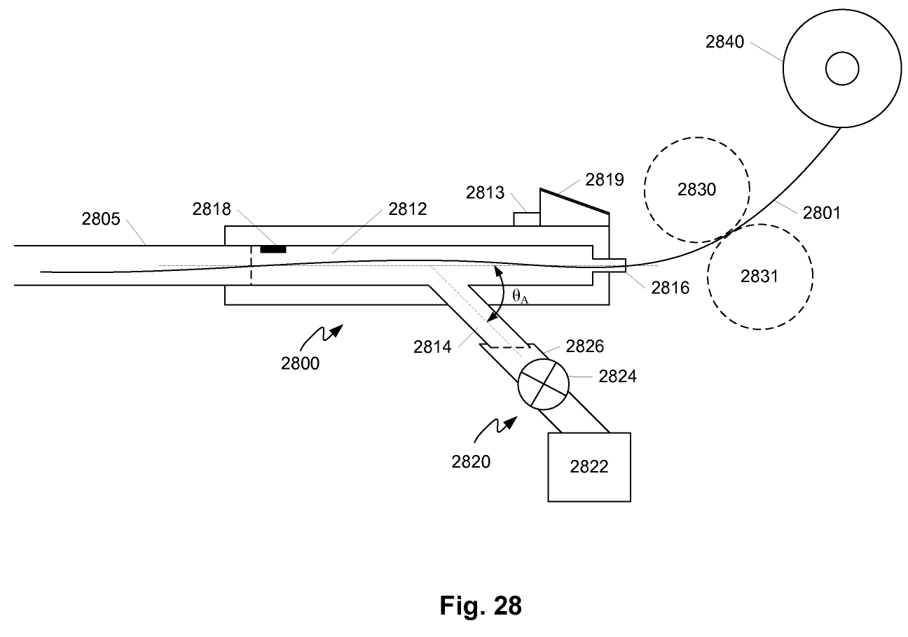

FIG. 28 illustrates a fiber blowing system including a schematic cross-sectional diagram of a fiber blowing device 2800 and associated components 2820, 2830 and 2840 that may be used to distribute fiber optic cable 2801 throughout a building. Various components including pressurized air dispenser 2820, drive wheels 2830 and distribution wheel 2840 may be used in conjunction with blowing device 2800 to convey fiber optic cable 2801 to a desired location. Pressurized air dispenser 2820 may include nozzle 2826 that may be connected to air inlet 2814 of blowing device 2800. Air dispenser 2820 may further include pressurized air source 2822 and air valve 2824 to control the dispensation of pressurized air from source 2822 to device 2800. The pressure of the air in source 2822 may depend on the weight of cable 2801 and a distance that cable 2801 is to be conveyed. The pressure needed to convey a particular cable such as cable 2801 may be determined using various calculations and methods known in the art.

Additionally or alternatively, drive wheels 2830 and 2831 may be used to aid in feeding cable 2801 through blowing device 2800 and into a fiber conduit such as conduit 2805. Blowing device 2800 may connect to conduit 2805 by inserting conduit 2805 into an opening at the head of blowing device 2800. In an alternate configuration, conduit 2805 may be connected to blowing device 2800 through a connector tube (not shown). Depending on the arrangement and characteristics of various portions of blowing device 2800 and/or pressurized air dispenser 2820, drive wheels 2830 and 2831 might not be necessary and/or included in the system. It is specifically recognized in at least one embodiment, wheels 2830 and 2831 are not needed to convey fiber cable 2801 through conduit 2805. That is, the drag force created by the pressurized air may be sufficient to propel cable 2801 through conduit 2805. Conduits such as conduit 2805 are generally pre-installed behind the drywall of a building to connect a cable source to a destination outlet. Additionally, conduit 2805 may be, in one or more arrangements, a flame retardant polyvinyl chloride (PVC) conduit having an inner diameter of 5 mm to facilitate the distribution of cable 2801. The inner diameter of conduit 2805 may, in some instances, determine a level of ease with which cable 2801 may be conveyed through conduit 2805 to the destination end. Conduit 2805 may further be constructed to accommodate cables having a pre-installed ferrule. One of skill in the art will appreciate, however, that conduits having a variety of inner diameters may be used to achieve similar results.

Fiber blowing device 2800 may have multiple elements including bore 2812, air inlet 2814, acoustic sensor 2818 and display 2819. As discussed, fiber blowing device 2800 may further include a connector tube (not shown) that may be used to connect fiber blowing device 2800 to conduit 2805. In either case, fiber 2801 may travel from a fiber dispensing reel 2840 through bore 2812 to conduit 2805. Bore 2812 may be characterized by an inlet end 2816 through which optical fiber 2801 may enter fiber blowing device 2800 from one or more sources. In one or more arrangements, the inner diameter of bore 2812 may be substantially larger than both the diameter of fiber 2801 and inlet end 2816. In particular, the inner diameter of inlet end 2816 might only be slightly larger than the diameter fiber 2801. This difference in diameter may aid in preventing air from escaping through inlet end 2816, thereby preserving any differences between the air pressure in bore 2812, tube 2810 and conduit 2805 and the atmospheric pressure at the destination end of conduit 2805.

Fiber blowing device 2800 uses pressure differentials between air inside conduit 2805 and fiber blowing device 2800 and the exterior air to create a drag force over the surface of fiber 2801. Depending on the surface area and diameter of fiber 2801, inner diameter of bore 2812 and/or the velocity of air flowing over the surface of fiber 2801, a drag force of sufficient magnitude to propel fiber 2801 through bore 2812, a connector tube (if used) and conduit 2805 may be generated. Various texturing and shaping of the surface of fiber 2801 may also be performed to improve and/or otherwise enhance the drag forces acting on fiber 2801. Additionally, the inner diameter of bore 2812 and/or conduit 2805 may further be determined based on one or more characteristics of a pre-installed ferrule attached to the head or front end of fiber 2801. The velocity of air flowing over fiber 2801 may depend on the pressure of air source 2822 as well as an angle of air inlet 2814 with respect to bore 2812. In one or more instances, air from air source 2822 may enter into inlet 2814 at a first velocity. However, due, at least in part, to the bend between inlet 2814 and bore 2812, the velocity of air that is passed through bore 2812 and into conduit 2805 may be degraded. As compared to air inlet 2814 being perpendicular to a central longitudinal axis of bore 2812, the air inlet may instead be at an angle θ_{A} to preserve air velocity and pressure. Passing air into bore 2812 at such an angle, θ_{A}, may increase the resultant velocity of air flowing throughout bore 2812 and conduit 2805 by reducing potential pressure losses over the bend between inlet 2814 and bore 2812. Air inlet 2814 may be positioned at a range of angles. In another arrangement and more specifically, air inlet 2814 may be positioned between 5° and 45° relative to the central longitudinal axis of bore 2812. In yet another arrangement, the angle may be between 5° and 20°.

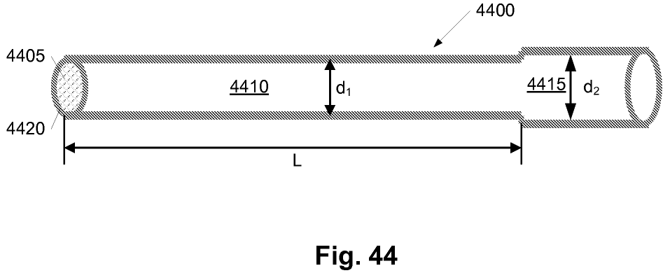

According to one or more aspects, fiber blowing device 2800 may further include acoustic sensing device 2818 and display 2819. Acoustic sensing device 2818 allows blowing device 2800 to determine a length of conduit 2805 or distance to a conduit destination using sonic detection. For example, acoustic sensing device 2818 may include an acoustic sensor as well as a sound emitting component. To determine the distance to the conduit destination, device 2818 may emit a short burst of sound using the sound emitting component. Once the burst of sound reaches the end of conduit 2805, the sound may be reflected back through conduit 2805. A reflection of sound may occur in response to a change in acoustic impedance between the interior and exterior of the end of conduit 2805. Alternatively or additionally, a device or structure, such as ferrule catcher 4400 of FIG. 44, may be attached to the node end of conduit 2805 and reflect sound emitted from the source end. The reflected burst of sound may subsequently be detected by the acoustic sensor of sensing device 2818. Device 2818 may then calculate a delay between the emission of the short burst of sound and the reception of the reflected burst of sound to determine the length of conduit 2805. Specifically, in one or more arrangements, the delay may be multiplied by the speed of sound to calculate a round trip distance (i.e., two lengths of conduit 2805) associated with the emission and reception of the burst of sound. The round trip distance may then be divided in half to approximate the length of conduit 2805.

Acoustic sensing device 2818 may be attached in a variety of places in fiber blowing device 2800. For example, acoustic sensing device 2818 may be attached to the inner wall of bore 2812. Including sensing device 2818 in fiber blowing device 2800 permits a user to determine the length of conduit 2805 without having to modify a connection to conduit 2805. That is, a user might not have to change the connection between conduit 2805 and different portions of device 2800 that correspond to measuring conduit distance and blowing fiber. By attaching sensing device 2818, both processes may be completed using the same connection point of device 2800.

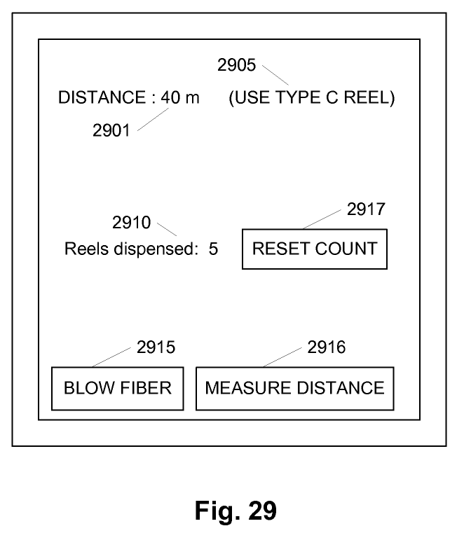

Additionally or alternatively, display 2819 may be used to notify a user of a conduit's length among other types of information. Display 2819 may be positioned in a location that is visible to one or more users when blowing device 2800 is connected to conduit 2805. For example, display 2819 may be situated toward the rear of fiber blowing device 2800 to enhance visibility for those standing behind device 2800. FIG. 29 illustrates a user interface 2900 having a variety of information displayed on display 2819. For example, upon measuring the distance to a destination outlet using an acoustic sensing device such as device 2818 (FIG. 28), the distance 2901 may be displayed on user interface 2900. Further, display 2819 may also notify the user of an appropriate type of reel 2905 to use based on the measured distance. For example, a user may have multiple reels of differing lengths available to him. Thus, display 2819 may advise the users of the type of reel to use for a given distance or length. Display 2819 may further display a counter 2910 that tracks a number of fibers or reels that have been blown by an associated fiber blowing device such as fiber blowing device 2800 of FIG. 28. Additionally, interface 2900 may include one or more touch sensitive command buttons 2915, 2916 and/or 2917. For example, button 2915 may command the device to begin blowing the fiber while button 2916 may instruct the device to measure the distance. One of skill in the art will appreciate that a variety of other information may be similarly displayed on display 2819 and interface 2900. Additionally, display 2819 and interface 2900 may be controlled via a processor such as processor 2813 integrated into the fiber blowing device 2800. Processor 2813 may be responsible for receiving data from one or more components such as acoustic sensing device 2818 and processing that data in one or more ways. Processor 2813 may further be signally coupled to a variety of components of device 2800 including display 2819, acoustic sensing device 2818, drive wheels 2830 and 2831 and air inlet 2814. For example, in one or more arrangements, display 2819 may be touch-sensitive. In such arrangements, processor 2813 may receive user commands and/or input from display 2819 and activate appropriate components, e.g., air inlet 2814, of device 2800.

According to yet another aspect, fiber blowing device 2800 may further include a longitudinal panel (not shown) for accessing bore 2812. The longitudinal panel may be used to release an optical fiber from blowing device 28100 once the fiber has been blown to the destination node or location. In one or more configurations, the longitudinal access panel may extend the entire length of device 2800. That is, the panel may extend from the head end of fiber blowing device 2800 to inlet end 2816. A variety of methods and systems for accessing bore 2812 and releasing a fiber from blowing device 2800 known in the art may also be used.

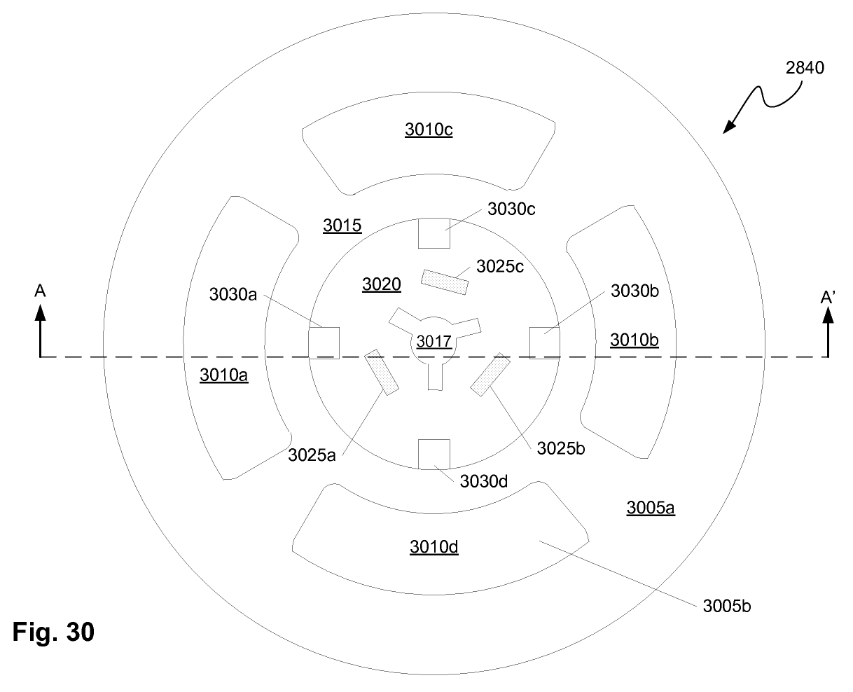

FIG. 30 is a diagram of fiber dispensing reel 2840 of FIG. 28. Fiber dispensing reel 2840 may be generally circular in shape to facilitate rotation about a central point. Reel 2840 includes reel walls 3005a and 3005b, windows 3010a, 3010b, 3010c, and 3010d, reel core 3015, reel eye 3017 and central recess 3020. Reel walls 3005a and 3005b may be used to prevent uncoiling or disengagement of optical fiber from reel core 3015 about which optical fiber may be coiled or wrapped. Windows 3010a, 3010b, 3010c and 3010d may be optionally included in either reel wall 3005a or 3005b or both to, among other things, allow a user to visually determine an amount of optical fiber remaining in reel 2840. Windows 3010a, 3010b, 3010c and 3010d may also facilitate user manipulation of optical fiber coiled around core 3015. As stated, windows 3010a, 3010b, 3010c and 3010d are optional and may be eliminated based on user preferences. Further, reel 2800 may be attached to a rotational axis through reel eye 3017. Reel eye 3017 extends through core 3015 and through both reel walls 3005a and 3005b.

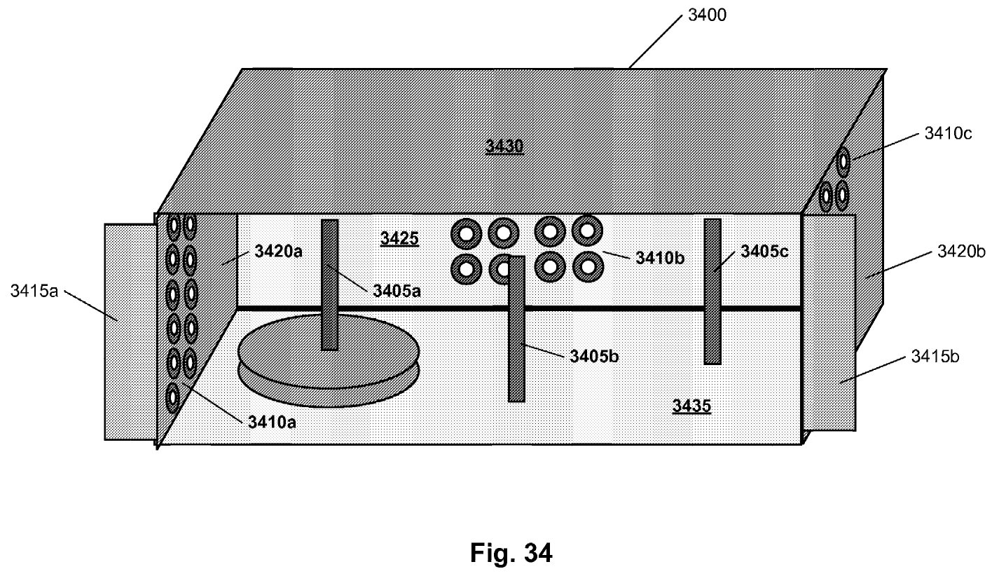

In one or more arrangements, a source portion of the optical fiber may be stored in central recess 3020 to prevent the portion from being blown through a conduit. For example, a portion of the fiber optic cable may be needed at the source end for connecting to a service provider cable or fiber originating from, e.g., service aggregation gateway (SAG) 101 of FIG. 1. The length of the tail may be predefined and/or standardized in accordance with one or more factors such as the dimensions of a storage device (e.g., ODF 3400 of FIG. 34). For example, in one or more arrangements, the length of the tail may be 1 m in length. To secure the tail portion of the optical fiber, central recess 3020 may include, for example, vertical ears 3025a, 3025b and 3025c. Thus, a connector installed on the end of the tail portion may be secured between at least one of vertical ears 3025a, 3025b and 3025c and wall 3027 surrounding and/or defining reel eye 3017. Additionally, recess 3020 may further include guard ears 3030a, 3030b, 3030c and 3030d to prevent the tail portion of the optical fiber from escaping out of recess 3020. The tail portion of the optical fiber portion may pass into recess 3020 through an opening (not shown) in core 3015. According to one or more aspects, the opening may be structured such that an optical fiber may be passed into recess 3020, but may resist any efforts to extract cable out of recess 3020. Thus, various aspects of reel 2840 may prevent a fiber blowing device such as device 2800 from unintentionally blowing the entire optical fiber (i.e., including the tail portion) through a conduit.

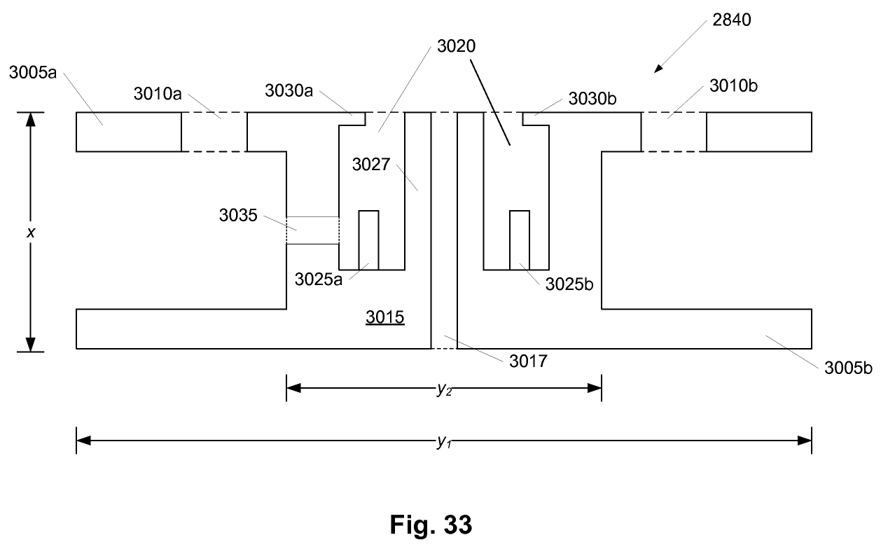

FIG. 33 is a cross-sectional diagram of reel 2840 taken along line A-A′ of FIG. 30. As described, reel 2840 includes reel walls 3005a and 3005b, windows 3010a and 3010b, core 3015, reel eye 3017 and recess 3020. Core 3015 may further include a fiber pass-through 3035. Fiber pass-through 3035 provides a passage through which an optical fiber coiled around core 3015 or a tail portion thereof may pass into recess 3020. Recess 3020 includes guard ears 3030a and 3030b which provide containment of an optical fiber or a tail portion thereof residing in recess 3020. Further, recess 3020 implements vertical ear structures 3025a and 3025b for securing a pre-installed fiber connector between the ear structure 3025a or 3025b and wall 3027 defining the reel eye 3017. In one or more embodiments, a first portion of an optical fiber may be coiled or wrapped around core 3015. A tail portion of the same optical fiber may then pass into recess 3020 through pass-through 3035. The tail portion may then be coiled about wall 3027. A connector end of the tail portion may be secured in the recess by inserting the connector between vertical ear 3025a and wall 3027. Fiber reel 2840 may further be attached to a fiber blowing device or other structures using reel eye 3017.

Fiber reel 2840 may be constructed from a variety of materials including one or more flame retardant plastics. The outside diameter (variable y₁ in FIG. 302) and depth (variable x) of reel 2840 as well as the outer diameter (variable y₂) of core 3015 may be defined based on a variety of factors including the length of the optical fiber to be stored on the reel and compatibility with a blowing device. In one or more embodiments, the outer diameter, y₁, of reel 2840 may be 140 mm while the diameter, y₂, of core 3015 may be 60 mm. Further, the depth of reel 2840 may be 14 mm. Alternatively or additionally, reel 2840 may also include a layer of foam on the exterior of at least one of reel walls 3005a and 3005b to provide padding when stacking reels on top of one another. The thickness of the layer of foam may vary depending on factors such as the weight of the reel and a maximum number of reels that may be stacked. For example, the thickness of foam of each reel may be 1.5 mm to allow stacking of 8 reels.

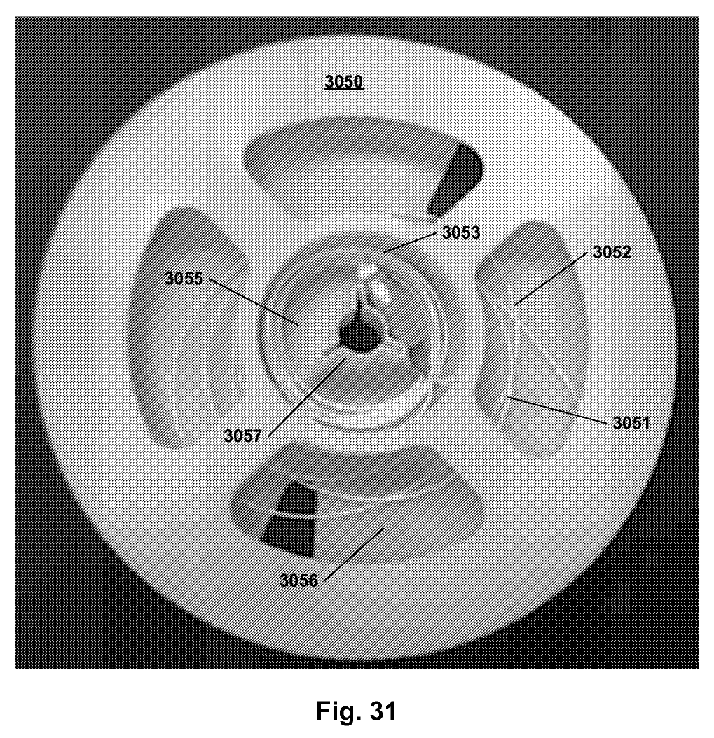

FIG. 31 is an illustration of reel 3050 including recess 3055, an interior reel portion 3056 and eye 3057. Reel 3050 further includes an optical fiber 3051 having head portion 3052 (which may be the portion of optical fiber 2801 blown by fiber blowing device 2800) stored in interior reel portion 3056 and tail section 3053 stored in recess 3055.

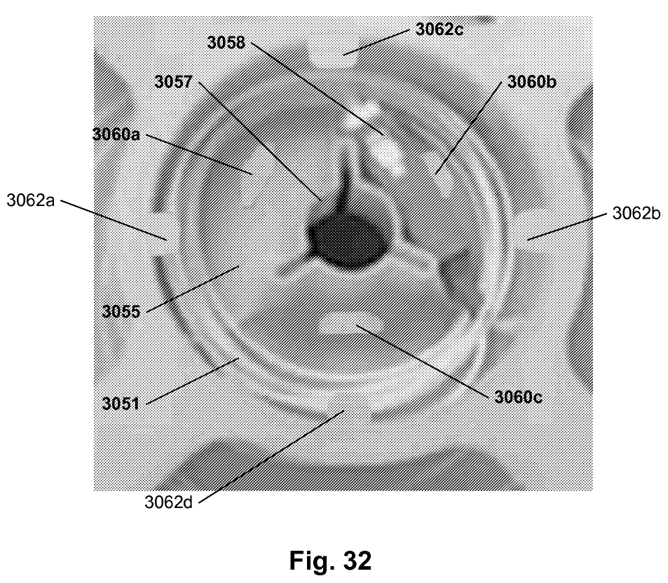

FIG. 32 is a zoomed in view of recess 3055 in a configuration that includes vertical ears 3060a, 3060b and 3060c as well as guard ears 3062a, 3062b, 3062c and 3062d. In one or more arrangements, a connector end 3058 of optical fiber 3051 may be secured between vertical ear 3060b and eye 3057 to prevent the tail portion of optical fiber 3051 from being dispensed from the reel. Guard ears 3062a, 3062b, 3062c and 3062d are configured to prevent the tail end of optical fiber 3051 from disengaging from recess 3055.

FIG. 34 is a front perspective view of an optical distribution frame (ODF) 3400 in an open position in which one or more aspects described herein may be implemented. For example, fiber reels (e.g., reel 2840 of FIG. 28) may be placed in ODF 3400 to facilitate organization and storage of multiple optical fibers blown to different destination outlets. ODF 3400 may include a variety of components such as mandrels 3405a, 3405b and 3405c, multiple sets of grommet openings 3410a, 3410b and 3410c and mounting brackets 341a and 3415b. ODF 3400 may be generally rectangular in shape having lateral sidewalls 3420a and 3420b, rear longitudinal wall 3425, top cover 3430, base plate 3435 and a front panel (not shown). Further, top cover 3430 may also be removable by unscrewing or sliding cover 3430 from the rest of ODF 3400. In one or more instances, ODF 3400 may be constructed in accordance with standard 19″ racks. In particular, ODF 3400 may be built with a 19″ width, 4 RU (i.e., 7″) height and a depth of 14″ so that ODF 3400 may be mounted into the aforementioned 19″ rack using, for example, brackets 3415a and 3415b. Alternatively, ODF 3400 may be mounted into a wall. A variety of materials may be used to construct ODF 3400 including steel sheets. Grommet openings of each set 3410a, 3410b and 3410c may be punched from the frame material using any number of commonly available tools. Each opening in sets 3410a, 3410b and 3410c may then be padded with a grommet such as a 3/16″ inner diameter rubber grommet or any other suitable sized grommet. The size of the rubber grommet and the openings may be determined based on one or more considerations including a size of a conduit used to blow the optical fibers to a destination point.

In one or more arrangements, different types and/or lengths of reels may be stored and organized in a storage device (not shown). Upon determining the length of fiber and/or type of reel, a user may refer to the organized arrangement of different reels in the storage device. More specifically, the storage device may contain different mandrels for different types of reels. In other words, a first mandrel may contain reels of a first length while a second mandrel may contain reels of a second length. Such an organization and storage facility may allow a user to more efficiently identify a proper reel and/or fiber during installation.

According to one or more arrangements, ODF 3400 may include 3 mandrels 3405a, 3405b and 3405c that may each hold up to 8 fiber reels such as reel 2840 of FIG. 28. Mandrels 3405a, 3405b and 3405c may be positioned such that reels placed on different mandrels do not obstruct one another. In one particular arrangement, mandrels 3405a and 3405c may be inline while mandrel 3405b may be longitudinally offset. The reels may be mounted to mandrels 3405a, 3405b and 3405c through a reel eye (e.g., reel eye 3017 of FIG. 30) of each reel. Foam padding on each reel may cushion the weight of the stacked reels. Further, each set of grommets 3410a, 3410b and 3410c may provide multiple inlets/outlets for optical fiber and/or connectors from the reels. For example, lateral sidewalls 3420a and 3420b and rear longitudinal wall 3425 may each have 24 grommet openings to allow a user the flexibility to choose a direction in which a particular connector or optical fiber should be blown. Thus, in one example, a first optical fiber may be blown through a first conduit connected to a grommet opening in side wall 3420a while a second optical fiber may be blown through a second conduit connected to a grommet opening in back wall 3425. In one or more embodiments, all the attached conduits may secured to grommet openings on only one of the lateral side walls. Conduits may be attached and/or connected to ODF 3400 using friction between the grommets and the conduit.

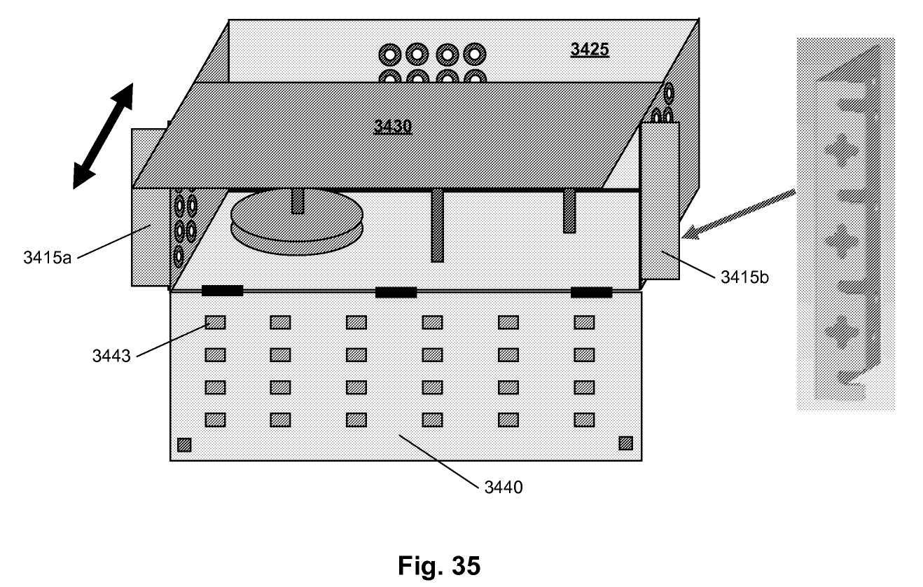

FIG. 35 is another diagram of ODF 3400 showing a removable configuration of top 3430 and a detailed diagram of brackets 3415a and 15b. FIG. 35 also illustrates front panel 3440 connected to base plate 3435 using multiple hinges. In one or more configurations, top cover 3430 may be removed during installation of the optical fibers so that fiber reels may be more easily placed onto mandrels 3405a, 3405b and 3405c. Top cover 3430 may be reattached once installation is complete.

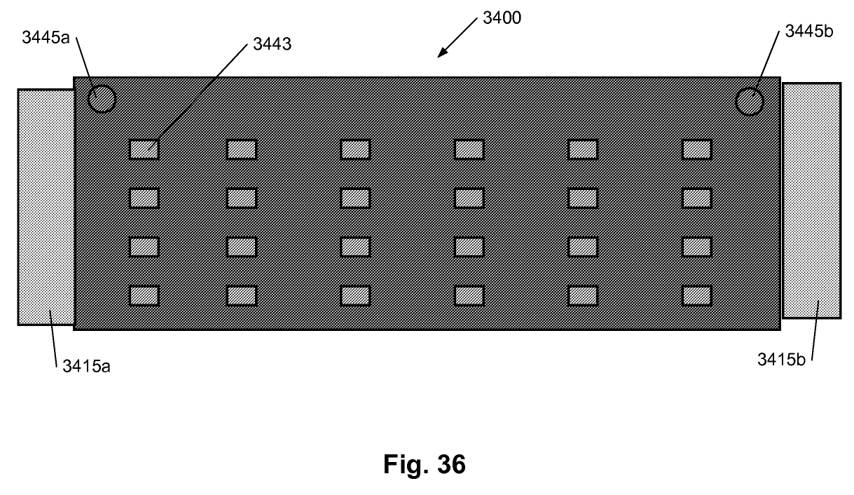

FIG. 36 is a diagram of ODF 3400 in a closed configuration. That is, FIG. 36 illustrates ODF 3400 with front panel 3440 covering the front opening. Front panel 3440 includes multiple SC/APC adapters and/or connectors 3443 as well as knobs 3445a and 3445b that may facilitate opening, closing and/or securing of ODF 3400. The number of SC/APC adapters 3443 included in front panel 3440 may be based on the number of optical fibers and/or reels that may be stored in ODF 3400. Thus, in one or more embodiments, since ODF 3400 may accommodate up to 24 distribution reels, front panel 3440 may include 24 SC/APC adapters 3443 (i.e., one adapter for reach reel/fiber). Front panel 3440 and associated adapters 3443 provide an organized method and system for connecting the blown fibers stored in ODF 3400 with external fibers or cables. For example, a source cable providing high speed networking service may be connected from SAG 101 (FIG. 1) to front panel 3440 through an SC/APC adapter to provide a particular optical fiber and/or destination outlet in a building with high speed networking capabilities. Front panel 3440 may be attached to the rest of ODF 3400 in a variety of ways including through the use of hinges attached to bottom base plate 3435 (FIG. 34). Alternatively, front panel 3440 may be hinged from top cover 3430 (FIG. 34).

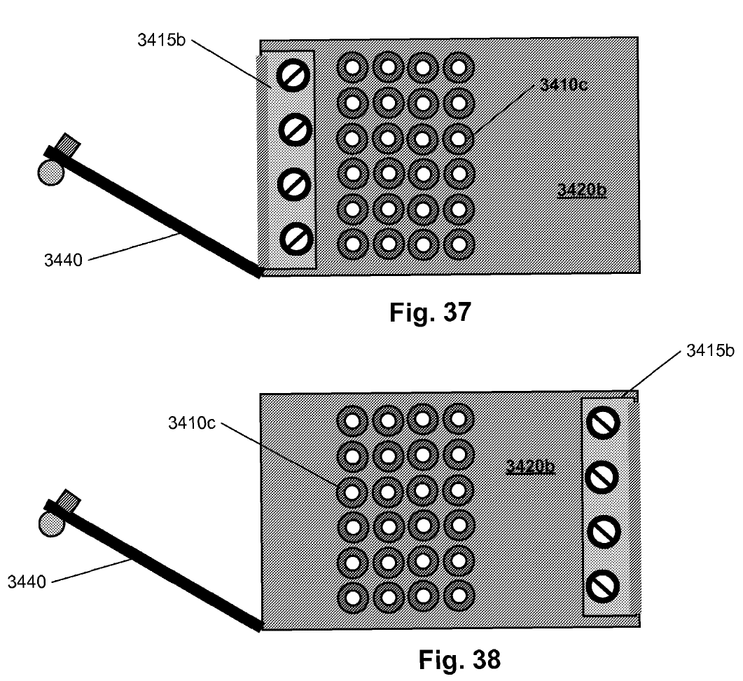

FIGS. 37 and 38 are side views of ODF 3400 in a rack mount configuration and a wall mount configuration, respectively. In FIG. 37 and in rack mount configurations, mounting bracket 3415b may be positioned at the front longitudinal section of lateral sidewall 3420b. In contrast, in wall mount configurations as illustrated in FIG. 38, mounting bracket 3415b may be positioned at the rear longitudinal section of lateral sidewall 3420b, instead. Mounting brackets 3415a and 3415b may be configured in a variety of positions depending on the structure to which ODF 3400 is to be mounted.

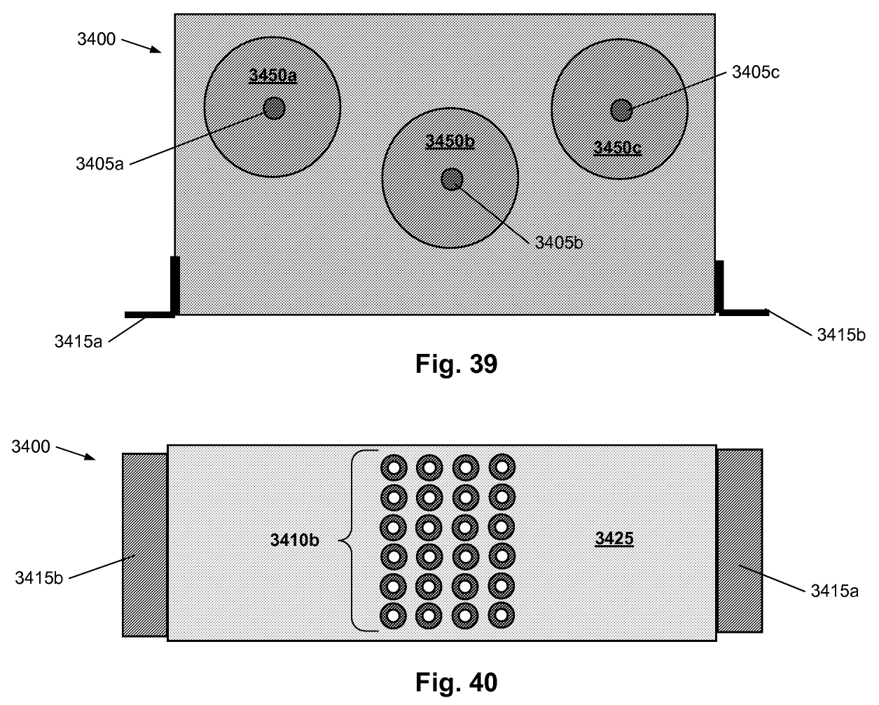

FIG. 39 is a top view of ODF 3400 with top cover 3430 removed. Reels 3450a, 3450b and 3450c are mounted to mandrels 3405a, 3405b and 3405c, respectively. With top cover 3430 removed, the placement and removal of reels 3450a, 3450b and/or 3450c may be facilitated.

FIG. 40 is a rear view of ODF 3400. Rear longitudinal wall 3425 of ODF 3400, as described herein, includes multiple grommet openings 3410b configured to secure multiple conduits.

One of skill in the art will appreciate that ODF 3400 is but one illustrative configuration that may be implemented. Various aspects of ODF 3400 may be modified and/or added to adapt to specific needs. For example, the number of mandrels may be increased to accommodate a larger number of reels. Similarly, the number of grommet openings may also be increased in accordance with the maximum reel capacity of ODF 3400. In yet another example, each of the grommet openings in sets 3410a, 3410b and 3410c and/or SC/APC adapters 3443 may be labeled with numbers, letters and/or other marks to facilitate organization and identification of various fiber connectors.

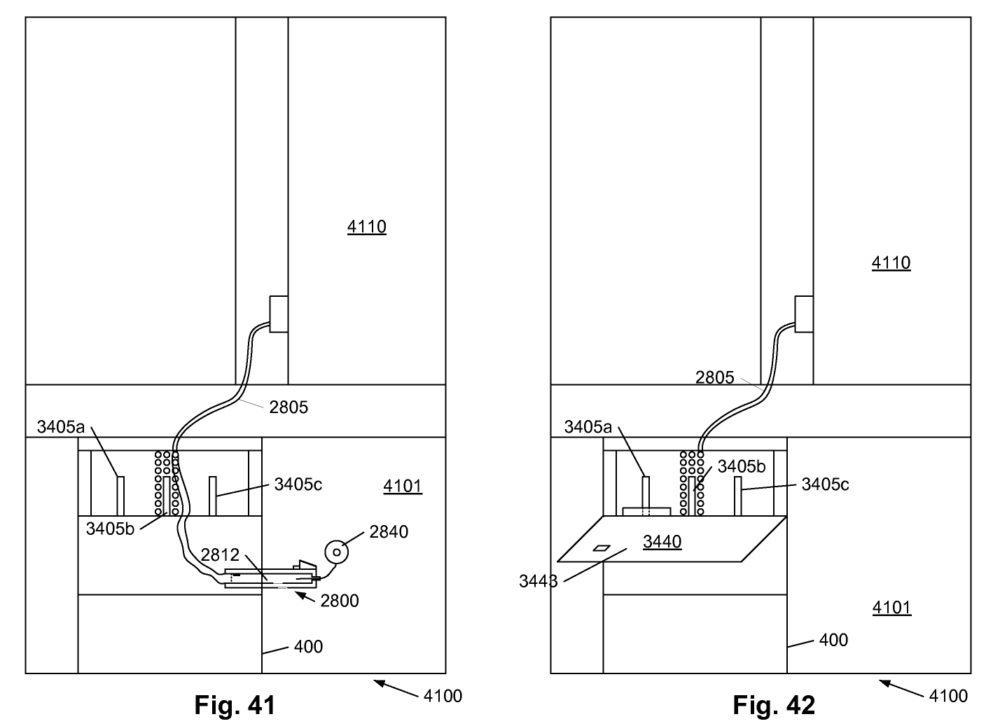

FIGS. 41 and 42 are diagrams illustrating two stages of a system and method for installing fiber optic cable in building 4100 using ODF 3400, fiber blowing device 2800 and fiber dispensing reel 2840. Referring to FIG. 41, conduit 2805 may be routed from room 4101, in which a service aggregation gateway like SAG 101 may be installed or provided, to a destination node or outlet of a second room such as room 4110. Conduit 2805 may be routed from one room to another using methods and systems known in the art. For example, conduit 2805 may be snaked behind walls from a source to a destination location. In room 4101, which may be configured to hold one or more rack units, SAG 101 may include rack 400 which is configured to hold multiple rack units (e.g., rack units 401, 402, 403 and 404 of FIG. 4). In one or more arrangements, at least one of the rack units may be and/or include an ODF such as ODF 3400. ODF 3400 may be mounted into rack 400 in a variety of ways including attaching brackets 3415a and 3415b to rack 400. Alternatively, ODF 3400 may be mounted to a wall in room 4101 rather than to rack 400.

Once ODF 3400 has been situated or configured, conduit 2805 may be threaded through a grommet opening in ODF 3400 and connected to fiber blowing device 2800, as described herein. Conduit 2805 may be extracted a sufficient length through the grommet opening and out of ODF 3400 to facilitate a connection with fiber blowing device 2800. In one or more instances, conduit 2805 may be connected to a connector tube of fiber blowing device 2800 or directly to fiber blowing device 2800. Fiber blowing device 2800 may measure the distance between room 4101 and room 4110 and identify a proper type and/or length of fiber reel to use as described herein. Once identified, an appropriate fiber reel is attached to fiber blowing device 2800 and a node end of an optical fiber in the reel is threaded into the bore (e.g., bore 2812 of FIG. 28) of fiber blowing device 2800. According to one or more arrangements, the node end of the optical fiber may include a pre-installed ferrule as described herein. Fiber blowing device 2800 may then blow the fiber with the pre-installed ferrule through conduit 2805 to destination room 4110. In room 4110, the fiber may subsequently be attached to and/or installed in an outlet such as universal outlet frame EO4 (FIG. 9) as described herein.

FIG. 42 is a diagram of a second stage of the installation system and method. Once the fiber has been blown through conduit 2805 to destination room 4110, conduit 2805 may be disconnected from fiber blowing device 2800 as described herein. A portion of conduit 2805 extending through the grommet opening may further be retracted into ODF 3400 to reduce conduit/wiring/cabling clutter. Additionally, reel 2840 may be detached from fiber blowing device 2800 and attached to one of mandrels 3405a, 3405b or 3405c for storage as described herein. Further, a tail portion of the optical fiber in reel 2840 may be extracted from reel 2840 and connected to an adapter or connector such as SC/APC adapter 3443 in front panel 3440 of ODF 3400. In one or more arrangements, the tail portion of the optical fiber may include a pre-installed connector compatible with SC/APC adapter 3443. A service provider cable or wire may be connected to the opposite end of SC/APC adapter 3443 (i.e., the exterior of panel 3440) to provide one or more services (e.g., Internet, cable, telephone) to the destination outlet and/or node as described herein. In one or more arrangements, the service provider cable may connect a service aggregation gateway such as SAG 101 of FIG. 1 with the fibers stored in ODF 3400. The system and method of installation described may be repeated for each outlet and/or destination node needed in building 100. Each optical fiber and/or conduit may be threaded through a different grommet opening. In addition, the optical fiber dispensing reels may be stacked on top of one another on mandrels 3405a, 3405b and/or 3405c.

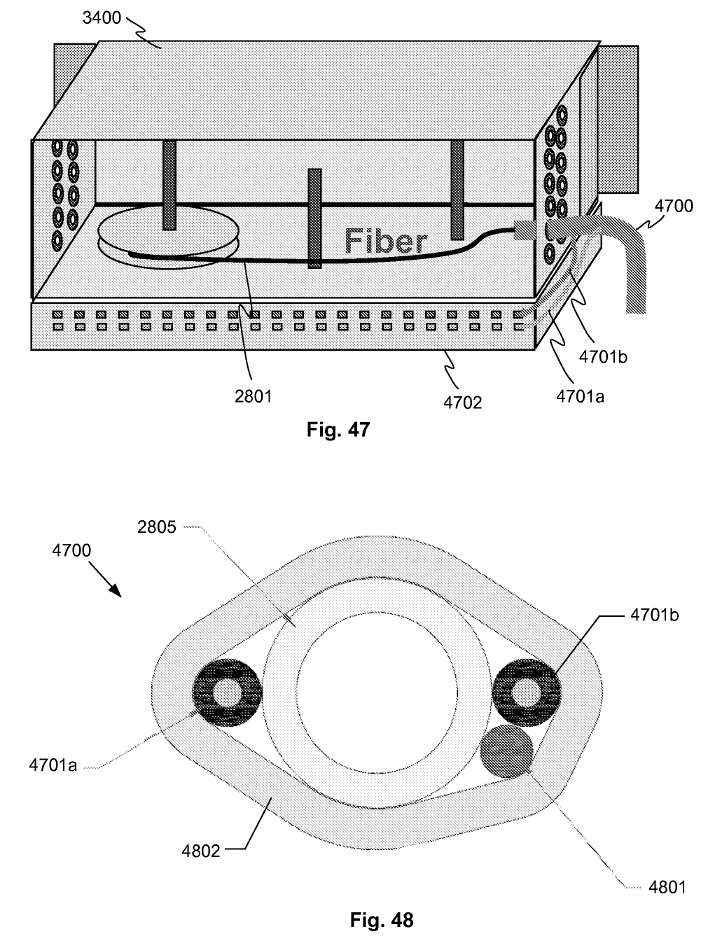

Referring to FIG. 47, conduit 2805 may be part of a larger structure that will be referred to herein as an optical/electrical delivery system 4700. Optical/electrical delivery system 4700 may effectively be in the form of a cable that includes both hollow conduit 2805 (through which, as described earlier, optical fiber 2801 may be blown) and a pair of electrically conductive wires 4701a, 4701b. Wires 4701a, 4701b may provide power to a user node unit such as user node unit 105 to which the other end of optical fiber 2801 is blown. In particular, wires 4701a, 4701b may provide electrical power to, for instance, a universal outlet frame of a user node, such as universal outlet frame 904a or 904b. Thus, for instance, wires 4701a, 4701b may be used as wires 1101 in FIG. 11.

In addition, a multi-output power supply 4702 may be provided as part of SAG 101, such as in rack 400. Power supply 4702 may include a plurality of individual power output connections to which the various wires (e.g., wires 4701a, 4701b) may be connected to receive power. Each power output connection may be independently or collectively driven, and each power output connection may have its own circuit breaker, such as a resettable circuit breaker. The power provided by power supply 4702 may be at any voltage desired, and may be AC or DC voltage. For instance, power supply 4702 may provide a regulated voltage in the range of about 24 volts to about 48 volts. Where the voltage provided over wires 4701a, 4701b is less than a particular voltage limit, depending upon the geographical jurisdiction, an electrician's license may not be legally required to prepare and run the electrical connections. For example, in many jurisdictions in the United States, this voltage limit is 60 volts.

Referring to FIG. 48, an illustrative cross-section of optical/electrical delivery system 4700 is shown. In this example, optical/electrical delivery system 4700 includes conduit 2805, wires 4701a, 4701b located outside of conduit 2805, and a rip cord 4801 located outside of conduit 2805, all wrapped in a flexible outer sheath 4802, such as a plastic and/or rubber sheath. Wires 4701a, 4701b may perform two functions, if desired. First, as previously described, wires 4701a, 4701b may conduct electrical power from power supply 4702 to a user node. Second, wires 4701a, 4701b may also provide strength to optical/electrical delivery system 4700 to allow it to be pushed/fished through walls without excessive bending. To provide such strength, wires 4701a, 4701b may be, for example, steel wires with an outer copper cladding. This is because, while steel is generally physically stronger than copper, copper generally provides better electrical conduction than steel. In one example, wires 4701a, 4701b may each be a 24 AWG insulated copper clad steel wire. In addition, wires 4701a, 4701b may be insulated from one another such as by physical separate and/or insulating material covering each wire. However, any size and configuration of wires may be used.

Rip cord 4801 may be made of any material that is strong enough to withstand pulling in order to rip open sheath 4802. Thus, rip cord 4801 may be used to peel away a portion of sheath 4802 to expose wires 4701a, 4701b and conduit 2805, thereby allowing those parts to be separated such that conduit 2805 may be directed to ODF 3400 and wires 4701a, 4701b may be directed to power supply 4702 as illustratively shown in FIG. 47.

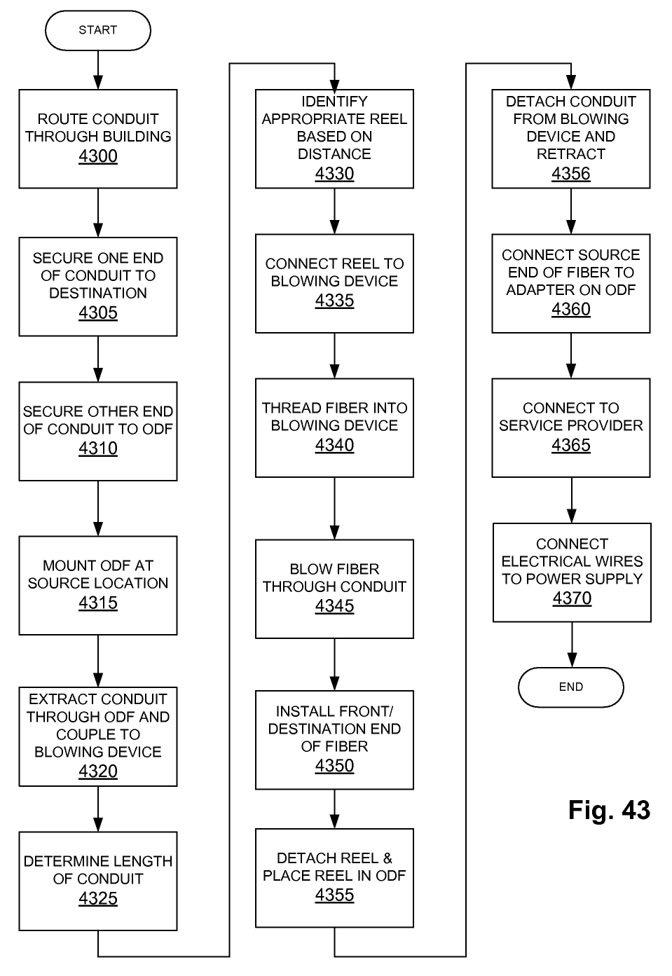

FIG. 43 is a flowchart illustrating a method for installing optical fiber in a building. The building may be any type of structure including a residential home, a commercial facility and/or an office building. In step 4300, one or more conduits for blowing optical fibers may be snaked or otherwise routed from a central room or location to the destination rooms where outlets and/or nodes are desired. The central room may include a service aggregation gateway where multiple services such as telephone, Internet and television service are provided into the building. In step 4305, each conduit may be clamped and/or otherwise secured to an outlet frame or a drywall of the destination room. For example, a conduit may be secured to a universal outlet frame mounted to a drywall of a particular destination room. Once attached to the destination outlet, a source end of the conduit may be connected to an ODF such as ODF 3400 of FIG. 34 in step 4310. The conduit may be attached to the ODF through a grommet opening in the ODF. Frictional force between the conduit and the grommet may secure the conduit in place.

In step 4315, the ODF may be mounted to one or more structures in the central location or room. For example, the ODF may be mounted to a rack or rack frame. Alternatively, the ODF may be mounted directly into a portion of the wall in the central room. The ODF may be mounted using brackets and/or other devices. One of skill in the art will appreciate that the ODF may be mounted at various times and is not restricted to the order illustrated in FIG. 43. In step 4320, the conduit may be extracted through the ODF a sufficient length to allow attachment/coupling of the conduit to a fiber blowing device such as blowing device 2800. In one or more arrangements, the conduit may be frictionally attached to the blowing device. The blowing device, in step 4325, may subsequently determine a length of the conduit or a distance from the central location to the destination node or outlet. Among other methods, the blowing device may employ acoustic sensors to measure the distance. The blowing device may further identify a particular type of reel or length of optical fiber corresponding to the determined distance in step 4330. Upon connecting the identified type of reel to the blowing device in step 4335, the optical fiber in the reel may be threaded into the bore of the blowing device in step 4340. In one or more embodiments, the node end (i.e., the end traveling to the destination location) of the optical fiber may include a pre-installed ferrule for attachment and/or installation with an outlet frame at the destination location. The optical fiber may then be blown through the conduit to the destination location in step 4345 without disconnecting or reconfiguring the conduit with respect to the blowing device.

After the optical fiber has been blown to the destination location, the node end of the optical fiber may be installed into an outlet frame at the destination location in step 4350. Conventionally, a node end of a blown optical fiber had to be fusion spliced and/or modified with mechanical connections to be installed in a destination outlet. Using an optical fiber with a node end having a pre-installed ferrule, such conventional methods for installing a node end to the destination outlet are not needed. In fact, the node end of the optical fiber with a pre-installed ferrule may be installed into the frame without modification or alteration to the blown fiber. Such a configuration may help to reduce costs and installation time. For example, a pre-installed ferrule on the node end of the optical fiber may be inserted into a universal outlet frame such as frame 904 (FIG. 9) compatible with the ferrule and fiber. Once the fiber has been secured at the destination location, the dispensing reel and conduit may each be disconnected and/or detached from the blowing device in steps 4355 and 4356, respectively. The conduit may also be retracted into the ODF to eliminate crowding and clutter of cables, wiring and conduits in step 4356. The dispensing reel, on the other hand, may be placed on a mandrel in the ODF for storage in step 4355. In one example, the dispensing reel may be stacked on top of another dispensing reel to conserve and maximize the use of space in the ODF. A source end of the optical fiber remaining in the reel may then be extracted from the reel and connected to an interior end of an adapter and/or connector installed in the front panel of the ODF in step 4360. The connector may extend through the front panel of the ODF allowing connections both on the exterior and the interior surfaces of the panel. In step 4365, service provider cable, wire and/or connector may then be connected to the exterior end of the adapter or connector in the front panel of the ODF to provide service to the destination outlet and/or location. In step 4370, wires 4701a, 4701b may be connected to power supply 4702 such as shown in FIG. 47.

The order in which many of the steps described with respect to the method of FIG. 43 are performed may be interchanged and are not necessarily bound to the order in which they are shown. For example, the order in which the optical fiber is installed at the destination location (step 4350) and at the source location (steps 4350-4365) may be interchangeable. That is, the node end optical fiber may be installed at the destination outlet after the source end of the optical fiber is installed or configured at the source or central location. As another example, step 4370 may be performed prior to any of the other steps of FIG. 43. As such, FIG. 43 illustrates but one order in which the installation steps may be performed.

FIG. 44 is a diagram of a ferrule catching device 4400 that may be used during fiber installation to prevent excess fiber from exiting the conduit at a destination outlet. Without ferrule catching device 4400, a large amount of fiber may be blown out of the conduit at the destination outlet. The excess fiber often must be stored in the outlet frame or retracted back through the conduit. Retraction of optical fiber through the conduit, however, may lead to breakage of the fiber. Ferrule catching device 4400 prevents a fiber with a pre-installed ferrule from being blown past a certain length. According to one or more aspects, ferrule catching device 4400 may include a screen like screen 4405 mounted to opening 4420 to prevent a ferrule from being blown past a certain distance or length. The length of fiber that is blown out of a conduit may be specified by a longitudinal length, L, of catching device 4400. For example, installing a fiber optic outlet at a particular destination location may require 6 inches of fiber. In such an instance, a ferrule catcher with a length of 6 inches may be used during installation to provide the appropriate length of fiber extending out of the conduit.

Ferrule catcher 4400 may further be characterized by a catcher section 4410 and an attachment section 4415. Attachment section 4415 may be greater in diameter than catcher section 4410 in order to mate to a conduit. Catching device 4400 may be created in a variety of ways including thermally enlarging the attachment section/end 4415 of a micro-duct of uniform diameter. A screen may then be attached and/or mounted to catching end 4420 using a variety of means including adhesives, friction and/or clamps. In one or more arrangements, the inner diameter d₂ of attachment section 4415 may be substantially equal to the outer diameter of a mating conduit. Such a configuration or arrangement allows the conduit to be inserted into attachment section 4415 and secured by frictional force. The inner diameter d₁ of catcher section 4410 may be the same as the inner diameter of the conduit to maintain the magnitude of drag on the fiber as the fiber moves from the conduit into catcher section 4410. Once the fiber is blown to end 4420 of catcher section 4410, the fiber may be prevented from blown/traveling any farther. Ferrule catching device 4400 may be detached after blowing the fiber, exposing the portion of the fiber extending out of the conduit. Ferrule catching device 4400 may be reused at other destination location and/or on other conduits that may require the same amount of excess fiber for installation.

Ferrule catching device 4400 may be installed prior to blowing a fiber through a conduit. For example, ferrule catching device 4400 may be attached to a conduit prior to snaking the conduit through the building in which fiber is to be installed. In another example, ferrule catching device 4400 may be attached to the conduit at the destination location after the conduit has already been installed through the building. Alternatively or additionally, the same ferrule catching device may be used for multiple conduits, thereby reducing the costs and materials associated with installing fiber in a building. In particular, ferrule catching device 4400 may be detached from a first conduit and attached to a second conduit after fiber has been blown through the first conduit.

Although a screen is described as being installed on the end of the catcher, any other configuration that allows blown air, but not the optical fiber, to pass through the device, may be used. For instance, a flexible or in-flexible net may be used instead of a screen.

What is claimed is:

1. An optical distribution frame comprising:
a housing having a plurality of openings each configured to receive at least one conduit therethrough;
a mandrel connected to the housing and configured to receive fiber dispensing reels; and
a plurality of optical connectors connected to the housing.

2. The optical distribution frame of claim 1, wherein each of the plurality of openings includes a grommet therein.

3. The optical distribution frame of claim 1, wherein the housing includes a first sidewall, a second sidewall, a front wall, a back wall, a top cover and a base, wherein the plurality of connectors are connected to the front wall and the plurality of openings are in one of the first wall, the second wall and the back wall.

4. The optical distribution frame of claim 3, wherein the plurality of openings includes a first set of openings located in the back wall and a second set of openings located in the first wall.

5. The optical distribution frame of claim 3, wherein the top cover is pivotably attached to the housing.

6. The optical distribution frame of claim 3, wherein the front wall is pivotably connected to the base.

7. The optical distribution frame of claim 3, wherein the plurality of openings includes a first set of openings located in the first sidewall, a second set of openings located in the second sidewall and a third set of openings located in the back wall, wherein each of the first, second and third sets of the plurality of openings include at least twelve openings.

8. The optical distribution frame of claim 7, wherein the housing further includes at least first and second laterally extending mounting brackets and first and second additional mandrels and wherein the front wall is pivotally connected to the base.

9. An optical fiber system comprising:
a plurality of conduits;
a plurality of fiber dispensing reels, each having a hole; and
a housing defining a volume including:
a plurality of openings, each of a size large enough to receive one of the plurality of conduits;
a plurality of mandrels extending into the volume; and
a plurality of optical connectors.

10. The system of claim 9, wherein one of the plurality of conduits extends through one of the plurality of openings.

11. The system of claim 10, wherein the one of the plurality of conduits is coupled to a fiber blowing device.

12. The system of claim 11, wherein the top cover is slidably coupled to the housing.

13. The system of claim 11, wherein the plurality of connectors are connected to the front wall and wherein the plurality of openings includes a first set of openings located in the first sidewall and a second set of openings located in the back wall.

14. The system of claim 9, wherein the optical distribution frame further includes a first sidewall, a second sidewall, a back wall, a front wall, a base and a top cover, wherein the front wall is pivotally connected to the base.

15. The system of claim 9, wherein each of the plurality of mandrels are configured to receive at least two of the plurality of fiber dispensing reels.

16. The system of claim 9, further comprising an air-permeable catching device configured to attach to an end of each of the plurality of conduits.

17. The system of claim 16, wherein the catching device includes:
a catching section having a first diameter and a first end, wherein an air-permeable screen is attached to the first end; and
an attachment section having a second diameter, wherein the second diameter is larger than the first diameter and wherein the attachment section is configured to attach to a fiber blowing conduit.

18. An optical distribution apparatus comprising:
a housing including a base, a first sidewall, a second sidewall, a back wall, a front wall and a plurality of openings;
a plurality of mandrels coupled to the housing; and
a plurality of fiber dispensing reels, each positioned on one of the plurality of mandrels, having an optical fiber wound therearound and having a hole, the optical fiber having a first end connected to a connector and the second end extending through one of the plurality of openings.

19. The apparatus of claim 18, wherein the second end of the optical fiber extends through a conduit attached to the one of the plurality of openings.

20. The apparatus of claim 18, further comprising a conduit connected to the one of the plurality of openings and wherein the second end of the optical fiber extends through the conduit.
